(19) United States
(12) Patent Application Publication
(10) Pub. No.: US 2007/0132387 A1
(43) Pub. Date: Jun. 14, 2007

(54) TUBULAR PLASMA DISPLAY

(76) Inventor: Chad B. Moore, Corning, NY (US)

Correspondence Address: BROWN & MICHAELS, PC;400 M & T BANK BUILDING, 118 NORTH TIOGA ST, ITHACA, NY, 14850, US

(21) Appl. No.: 11/609,093

(22) Filed: Dec. 11, 2006

Related U.S. Application Data
(60) Provisional application No. 60/749,446, filed on Dec. 12, 2005.
(60) Provisional application No. 60/759,704, filed on Jan. 18, 2006.
(60) Provisional application No. 60/827,146, filed on Sep. 27, 2006.
(60) Provisional application No. 60/827,152, filed on Sep. 27, 2006.
(60) Provisional application No. 60/827,170, filed on Sep. 27, 2006.

(51) Int. Cl. H01J 17/49

(52) U.S. Cl. 313/582

(57) ABSTRACT

A tubular plasma display (TPD) is composed of an electroded sheet (electroded sheet) attached to an array of plasma tubes. Both the electrode sheet and the plasma tube array contain wire electrodes, which create very electrically conductive lines and the ability to address very large displays. The electroded sheet is composed of a thin flexible polymer substrate with embedded wire sustain electrodes. Each plasma tube is individually sealed and contains a wire address electrode, a hard emissive coating, a color phosphor and a Xenon based plasma gas. Polymer-based color filter coatings may also be applied to the surface of the plasma tubes after they are gas processed and sealed to drastically increase the bright room contrast, brightness, and color purity of the display.

### REFERENCE TO RELATED APPLICATIONS

This application claims an invention that was disclosed in one or more of the following provisional applications:

1) Provisional Application Number Provisional Application No. 60/749,446, filed Dec. 12, 2005, entitled “ELECTRODE ADDRESSING PLANE IN AN ELECTRONIC DISPLAY”;

2) Provisional Application No. 60/759,704, filed Jan. 18, 2006, entitled “ELECTRODE ADDRESSING PLANE IN AN ELECTRONIC DISPLAY AND PROCESS”;

3) Provisional Application No. 60/827,146, filed Sep. 27, 2006, entitled “TUBULAR PLASMA DISPLAY”;

4) Provisional Application No. 60/827,152, filed Sep. 27, 2006, entitled “ELECTRODED SHEET”; and

5) Provisional Application No. 60/827,170, filed Sep. 27, 2006, entitled “WIRE-BASED FLAT PANEL DISPLAYS”.

The benefit under 35 USC §119(e) of the United States provisional applications is hereby claimed, and the aforementioned applications are hereby incorporated herein by reference.

### BACKGROUND OF THE INVENTION

1. Field of the Invention

The invention pertains to the field of plasma display panels. More particularly, the invention pertains to using glass tubes, to construct one half of a color plasma display panel and an electroded sheet (eSheet) to create the other half of the plasma display.

2. Description of Related Art

Plasma display panels (PDP) have been around for 40 years, however, color PDPs did not receive much attention until the invention of the three electrode surface discharge structure (G. W. Dick, “Three-Electrode per PEL AC Plasma Display Panel”, 1985 International Display Research Conf., pp. 45-50; U.S. Pat. Nos. 4,554,537, 4,728,864, 4,833,463, 5,086,297, 5,661,500, and 5,674,553). The three electrode surface discharge structure, shown in FIG. 1, advances many technical attributes of the display, but its complex manufacturing process and detailed structure makes manufacturing complicated and costly.

Currently, plasma display structures are built up layer by layer on specialty glass substrates using many complex processing steps. FIG. 1 illustrates the basic structure of a surface discharge AC plasma display made using standard technology. The PDP can be broken down into two parts: top plate 10 and bottom plate 20. The top plate 10 has rows of paired electrodes referred to as the sustain electrodes 11a, 11b. The sustain electrodes are composed of wide transparent indium tin oxide (ITO) electrodes 12 and narrow Cr/Cu/Cr bus electrodes 13. These electrodes are formed using sputtering and multi-layer photolithography. The sustain electrodes 11 are covered with a thick (25 μm) dielectric layer 14 so that they are not exposed to the plasma. Silk-screening a high dielectric paste over the surface of the top plate and consolidating it in a high temperature process step forms this dielectric layer 14. A magnesium oxide layer (MgO) 15 is deposited by electron-beam evaporation or sputtering over the dielectric layer to enhance secondary emission of electrons and improve display efficiency. The bottom plate 20 has columns of address electrodes 21 formed by silk-screening silver paste and firing the paste in a high temperature process step. Barrier ribs 22 are then formed between the address electrodes 21. These ribs 22, typically 50 μm wide and 120 μm high, are formed using either a greater than ten layer multiple silk-screening process, embossing a frit paste, or a sandblasting process. In the sandblasting method, barrier rib paste is blade coated on the glass substrate. A photoresist film laminated on the paste is patterned by photolithography. The rib structure is formed by sandblasting the rib paste between the exposed pattern, followed by removal of the photoresist layer and a high temperature consolidation of the barrier rib 22. Alternating red 23R, green 23G, and blue 23B phosphors are silk-screened into the channels between the barrier ribs to provide color for the display. After silk-screening the phosphors 23, the bottom plate is sandblasted to remove excess phosphor in the channels. The top and bottom plates are frit sealed together and the panel is evacuated and backfilled with a gas mixture containing xenon.

The basic operation of the display requires a plasma discharge where the ionized xenon generates ultraviolet (UV) radiation. This UV light is absorbed by the phosphor and emitted as visible light. To address a pixel in the display, an AC voltage is applied across the sustain electrodes 11, which is large enough to sustain a plasma, but not large enough to ignite one. (A plasma is a lot like a transistor, as the voltage is increased nothing happens until a specific voltage is reached where it turns on.) Then an additional short voltage pulse is applied to the address electrode 21, which adds to the sustain voltage and ignites the plasma by adding to the total local electric field, thereby breaking down the gas into a plasma. Once the plasma is formed, electrons are pulled out of the plasma and deposited on the MgO layer 15. These electrons are used to help ignite the plasma in the next phase of the AC sustain electrodes. To turn the pixel off, an opposite voltage must be applied to the address electrode 21 to drain the electrons from the MgO layer 15, thereby leaving no priming charge to ignite the plasma in the next AC voltage cycle on the sustain electrodes. Using these priming electrons, each pixel can be systematically turned on or off. To achieve gray levels in a plasma display, each video frame is divided into 8 bits (256 levels) and, depending on the specific gray level, the pixels are turned on during these times.

An entirely new method of manufacturing plasma displays using complex-shaped fibers containing wire electrodes to build the panel structure in a display solved many of the cost and size issues involved with manufacturing PDPs (C. Moore and R. Schaeffler, “Fiber Plasma Display”, SID '97 Digest, pp. 1055-1058; U.S. Pat. No. 5,984,747 GLASS STRUCTURES FOR INFORMATION DISPLAYS, herein incorporated by reference). The fiber-based method of manufacturing creates plasma displays that look and operate identical to the traditional panel structure, FIG. 1, but the structure in the panel is totally fabricated using complex-shaped glass fibers containing wire electrodes, as shown in FIG. 2.

The entire functionality of the standard plasma display (FIG. 1) is created by replacing the top 16 and bottom 24 plates with respective sheets of top 17 and bottom 27 fibers (FIG. 2) sandwiched between plates (16 and 24) of soda lime glass. Each row of the bottom plate is composed of a single fiber 27 that includes the address electrode 21, barrier ribs 22, plasma channel 25 and the phosphor layers 23. Each column of the top plate is composed of a single fiber 17 that includes two sustain electrodes 11 and a thin built-in dielectric layer 14 over the electrodes 11a and 11b which is covered with a MgO layer 15.

All of the glass fibers are preferably formed using a fiber draw process similar to that used to produce optical fiber in the telecommunications industry. The glass fibers are drawn from a large glass preform, which is formed using hot glass extrusion. Metal wire electrodes are fed through a hole in the glass preform and are co-drawn with the glass fiber. The phosphor layers 23 are subsequently sprayed into the channels 25 of the bottom fiber 27 and a thin MgO coating 15 is applied to the top fiber 17. Sheets of top 17 and bottom fibers 27 are placed between two glass plates (16 and 24). The glass plates are frit sealed together with the wire electrodes extending through the frit seal. The panel is evacuated and backfilled with a xenon-containing gas and the wire electrodes are directly connected to the drive circuitry.

There are several advantages to creating plasma displays using arrays of fibers. The largest advantage is a reduction of over a factor of 2 in the manufacturing costs of the panel with a 10 times less capital cost requirement. These economical advantages result from a manufacturing process with no multi-level alignment process steps, no need for large area vacuum deposition equipment, about ½ the process steps (potentially leading to higher yields), simpler process steps (hot glass extrusion, fiber draw, and phosphor spraying compared to photolithography, precision silk screening, and vacuum deposition processes) and the ability to create many different size displays using the same manufacturing equipment. Although using fibers to create the structure in a display has drastically simplified the manufacturing of the panel leading to a large reduction in manufacturing cost, the initial fiber-based work had no advancements to the performance of the display.

Much advancement in fabricating fiber-based plasma displays have been achieved since the initial invention. Some process improvements in fabricating fiber-based displays are listed in U.S. Pat. Nos. 6,247,987 and 6,354,899, which include fiber, array and panel forming processes. These patents are hereby incorporated herein by reference. Since plasma displays still suffer from low luminous efficiencies and poor bright room contrast there has been a focus on using fibers to help solve some of these issues. U.S. Pat. No. 6,414,433, herein incorporated by reference, is the first indication of controlling the intra-pixel shape to increase the plasma efficiency and U.S. Pat. No. 6,771,234, also incorporated herein by reference, shows methods of increasing the length of the plasma glow to increase the displays efficiency. Adding a color filter to a display increases the bright room contrast because it subtracts out ⅔ of the reflected light (i.e. the red pixel absorbs green and blue). In traditional plasma display panels (PDPs), the concept of adding a color filter was first patented by Pioneer Electronic Corporation in U.S. Pat. No. 5,838,105, herein incorporated by reference. NEC Corporation has been fabricating plasma displays using a color filter contained within the top plate and aligning the color filter with the corresponding phosphor colors in the bottom plate, as described in U.S. Pat. No. 6,072,276, herein incorporated by reference.

One of the best methods of adding a color filter to a fiber-based plasma display is to flip the entire fiber panel upside down, as covered in U.S. Pat. No. 6,570,339, herein incorporated by reference, and shown in FIGS. 3 and 4. In these examples the fibers 47 are composed of a colored glass and are on the side of the display facing the view. The light generated from the color phosphors 23 has to be transmitted through the colored glass fibers 47B, 47G, and 47R, which increases the color purity of the display. Any incident light on the panel will be partially absorbed by the colored fibers 47, hence increasing the bright room contrast. Curved displays up to 360 degrees can be fabricated as covered under U.S. Pat. No. 6,750,605, herein incorporated by reference, because the fibers can be bent and curved glass plates can be used as the vacuum vessel. Adding lenses to the surface of the fibers also allows for the fabrication of multiple view and 3-dimenstional display as covered in U.S. Pat. No. 7,082,236, incorporated herein by reference.

Small hollow tubes were first disclosed in 1974 in U.S. Pat. No. 3,602,754 CAPILLARY TUBE GAS DISCHARGE DISPLAY PANELS AND DEVICES assigned to Owens-Illinois and incorporated herein by reference. This patent was followed by U.S. Pat. Nos. 3,654,680, 3,927,342 and 4,038,577, all herein incorporated by reference, which explain methods of creating a plasma display using small glass tubes, as shown in FIG. 5. These patents cover using small glass tubes (T) with conductors (C) applied to the outside surface of the tubes. Although Owens-Illinois had the initial tubular plasma display patents all the initial work on tubular plasma displays was done by Control Data. Control Data focused on using an array of gas filled hollow tubes to produce the rib structure in a plasma display panel (PDP). The electrodes to ignite the plasma inside the tubes were placed on a glass or plastic substrate and the electroded substrates were sandwiched around the gas filled hollow tubes, as shown in FIG. 6. The Control Data work was published by W. Mayer and V. Bonin, “Tubular AC Plasma Panels,” 1972 IEEE Conf. Display Devices, Conf. Rec., New York, pp. 15-18, and R. Storm, “32-Inch Graphic Plasma Display Module,” 1974 SID Int. Symposium, San Diego, pp. 122-123 and included in U.S. Pat. Nos. 3,964,050 and 4,027,188, all herein incorporated by reference. Control Data Corporation also received three US Air Force contracts to develop the tubular plasma display: AD-728623, “Large Screen Plasma Display”, 1971; AD-782383, “Large Area Plasma Display Module”, 1974; and AD-766933, “Plasma Display Color Techniques Using Tubular Construction”, 1973, incorporated herein by reference. In the last U.S. Air Force contract, Control Data focused on adding color phosphors inside the plasma tubes to create a multicolor tubular plasma display. Control Data also discloses depositing a work-function lowering substance inside the discharge tubes.

The only other known group working or having worked on tubular plasma displays is Shinoda's group at Fujitsu in Japan. The first tubular publications or patents from the Fujitsu group were in 2000. Shinoda's group has patented a method of coating a separate setter with a phosphor layer and inserting it into a plasma tube, as discussed U.S. Pat. Nos. 6,577,060, 6,677,704, 6,794,812, 6,836,063, 6,841,929, 6,930,442, 6,932,664, 6,969,292, and 7,049,748, all herein incorporated by reference. Shinoda's group at Fujitsu has also published several papers on tubular plasma display: T. Shinoda et al. “New Approach for Wall Display with Fine Tube Array Technology” SID 2002, pp. 1072-1075; M. Ishimoto et al. “Discharge Observation of Plasma Tubes”, SID 2003 pp. 36-39; H. Hirakawa et al., “Dynamic Driving Characteristics of Plasma Tubes Array”, SID 2004, pp. 810-813; Awanoto et al., “Development of Plasma Tube Array Technology for Extra-Large-Area Displays”, SID 2005, pp. 206-209.

There is a need in the art for a durable, easy to manufacture, low cost method of forming a tubular plasma display.

### SUMMARY OF THE INVENTION

The present invention includes a new tubular plasma display that can be very economically manufactured in very large sizes, that is very light weight, incorporates a color filter to solve the bright room contrast issue and can be rolled or bent.

The tubular plasma display (TPD) is composed of an electroded sheet (eSheet) and an orthogonal array of plasma tubes both containing wire electrodes that are connected directly to drive electronics. The electroded sheet is composed of a thin (preferably <0.005″ thick) flexible polymer substrate with embedded wire electrodes. More than one wire electrode may be used per electrode line and a transparent conductive coating may be attached to the wire(s) to spread the extent of the electric field. In order to create a durable flexible electroded sheet, the transparent conductive electrode is preferably composed of a polymer-based material, like Baytron, or carbon nanotubes.

Each tube in the plasma tube array preferably contains at least one wire electrode, a hard emissive coating (containing carbon nanotubes in one embodiment), and a color phosphor and is individually sealed containing a plasma gas. Polymer-based color filter coatings may also be applied to the surface of the plasma tubes after they are gas processed and sealed to drastically increase the bright room contrast, brightness, and color purity of the display. The plasma tubes are preferably created using hot glass extrusion followed by a tube draw, therefore tight dimensional control is obtained and the intra pixel shape may be tailored to provide for the most efficient plasma kinetics.

Since the electrodes in both the electroded sheet and the plasma tube array are preferably composed of very conductive wires, extremely large tubular plasma displays may be addressed. The thin lightweight flexible electroded sheets may be bonded to one surface of the plasma tube array using a pressure sensitive adhesive. The wire electrodes from the plasma tubes may extend away from the tube array and be electrically connected to the drive electronics at a 90 degree angle from the ends of the tubes. Therefore, the panel is capable of being tightly rolled across the tube direction creating a color video display that may be rolled up around a pencil. These tubular plasma displays (TPDs) only require a few manufacturing process steps none of which are alignment process steps, photolithography steps nor large vacuum deposition equipment. Therefore, very large tubular plasma displays can be economically manufactured.

### BRIEF DESCRIPTION OF THE DRAWINGS

FIG. 1 illustrates a standard plasma display in accordance with the prior art.

FIG. 2 illustrates a fiber-based plasma display with all functions of the display integrated into the fibers with embedded wire electrodes in accordance with the prior art.

FIG. 3 illustrates a fiber-based plasma display composed of an array of fibers containing the phosphor coatings on the side facing the viewer and an array of fibers containing the sustain electrodes in accordance with the prior art.

FIG. 4 illustrates a fiber-based plasma display composed of an array of fibers containing the phosphor coatings on the side facing the viewer in accordance with the prior art.

FIG. 5 illustrates a plasma display with plasma tubes and electrode films attached to the outside of the plasma tubes in accordance with the prior art.

FIG. 6 illustrates a plasma display with plasma tubes in accordance with the prior art.

FIG. 7 illustrates a tubular plasma display with wire electrodes embedded in the plasma tubes and an electroded sheet containing wire electrodes.

FIG. 8 is a photograph of a tube array connected to an electroded sheet.

FIG. 9 is a photograph of a tube array connected to an electroded sheet that is rolled around a pencil.

FIG. 10 schematically shows a cross-section of an electroded sheet with wire electrodes embedded in the surface of the film.

FIG. 11 schematically shows a cross-section of an electroded sheet with two wire electrodes per line embedded in the surface of the film.

FIG. 12 schematically shows a cross-section of an electroded sheet with wire electrodes embedded in the surface of the film where the wire electrodes are electrically connected to a transparent conductive film.

FIG. 13 schematically shows a cross-section of a plasma tube containing a wire electrode.

FIG. 14 schematically shows a cross-section of a plasma tube containing a wire electrode where the wire electrode is extended up into the plasma to be located closer to the top addressing surface.

FIG. 15 schematically shows a cross-section of a plasma tube containing two wire address electrodes in the sides of the tube located close to the top addressing surface.

FIG. 16 schematically shows a cross-section of a plasma tube containing two wire electrodes located in the bottom of the plasma tube.

FIG. 17 schematically shows a cross-section of a plasma tube containing two wire electrodes located in the sides of the plasma tube.

FIG. 18 schematically shows a cross-section of a plasma tube containing two wire electrodes located in the sides of the plasma tube where the glass around the wire electrodes have structure to enhance the firing of the plasma.

FIG. 19 schematically shows a cross-section of a plasma tube containing two wire address electrodes in the sides of the tube located close to the top addressing surface where the glass around the wire electrodes have structure to enhance the addressing of the plasma.

FIG. 20 schematically shows a cross-section of a plasma tube containing two wire electrodes located in the bottom of the plasma tube with a spike in the glass around the wire electrodes to enhance the addressing of the plasma and structure on the outside walls of the tube to redirect light.

FIG. 21 schematically shows a cross-section of a plasma tube containing two wire electrodes located in the bottom of the plasma tube where the sides of the tubes are curved to increase its flexibility when bent in a panel.

FIG. 22 schematically shows a cross-section of a plasma tube containing a wire electrode with a thick curved base to enhance the mechanical strength of the plasma tube.

FIG. 23 schematically shows a cross-section of a plasma tube containing a wire electrode with very thin walls to create a very light weight tube array.

FIG. 24 schematically shows a cross-section of a plasma tube containing a hard emissive coating on one surface and a phosphor coating on the other surfaces.

FIG. 25 schematically shows a cross-section of a plasma tube containing color filters applied to the surface of the tube.

FIG. 26 schematically shows a cross-section of a plasma tube composed of a colored base glass and having color filters on the surface of the tube.

FIG. 27 schematically shows a cross-section of a plasma tube containing a hard emissive coating containing nanotubes on one surface and a phosphor coating on the other surfaces.

FIG. 28a schematically shows a cross-section of a plasma tube with a reflective side and an absorbing side.

FIG. 28b illustrates an array of tubes in FIG. 28a illuminated with sun light.

FIG. 29a schematically shows a cross-section of a plasma tube being coated with an electron emissive coating containing nanoemitters on one surface and the tips of the glass around the address electrodes.

FIG. 29b schematically shows a cross-section of a plasma tube in FIG. 29b further being coated with a phosphor layer.

FIG. 30 schematically shows the root of the tube draw process where phosphor and a MgO layer may be coated inside the plasma tubes during the draw process by delivering the materials through small tubes into the root of the tube.

FIG. 31 schematically shows a phosphor coated fiber containing a wire electrode inserted into a tube.

FIG. 32 schematically shows three (red/green/blue) phosphor coated fibers containing wire electrodes inserted into a tube.

FIG. 33 schematically shows a wing shaped phosphor coated fiber containing a wire electrode inserted into a tube.

FIG. 34 schematically shows a cross-section of a wire electrode in a glass fiber or tube with a conductive media around the wire to remove the capacitive drop between the wire electrode and the inner surface of the glass fiber or tube.

FIG. 35 schematically shows a phosphor coated fiber containing a conductive coating on the bottom surface and a wire electrode inserted into a tube where the wire electrode makes electrical contact with the conductive coating.

FIG. 36 schematically shows a phosphor coated fiber and wire electrodes inserted into a tube where the wire electrodes are surrounded by a sea of conductive particles which make electrical connection to the wire electrodes and remove the capacitive void between the wire electrode and the bottom of the phosphor coated fiber.

FIG. 37 schematically shows a phosphor coated fiber and a MgO coated fiber placed inside a tube such that the fibers are located within the seals.

FIG. 38 schematically shows a fiber containing two plasma channels with phosphor coatings and wire address electrodes located at the bottom of the plasma channels inserted into a tube to create a double-sided tubular plasma display.

FIG. 39 schematically shows a fiber containing two plasma channels with phosphor coatings and wire address electrodes in the walls of the fiber inserted into a tube to create a double-sided display.

FIG. 40a schematically represents inserting a phosphor and an MgO coated setter with release coating inside a wire containing plasma tube.

FIG. 40b shows the resulting MgO and phosphor coatings on the inner tube wall surfaces after the coating are released and the setter is removed from FIG. 40a.

FIG. 41a schematically shows a cross-section of a polymer fiber coated with an emissive coating and a phosphor layer.

FIG. 41b schematically shows a cross-section of the coated polymer fiber in FIG. 41a inserted into a plasma tube such that the coatings can be transferred.

FIG. 42 schematically shows the root of a fiber or tube draw process showing the forces exerted in the root above and below the point of inflection.

FIG. 43a schematically shows the shape and forces exerted on a rectangular tube preform as it is being drawn down while in a location above the point of inflection as shown in FIG. 42.

FIG. 43b schematically shows the shape and forces exerted on a rectangular tube preform as it is being drawn down while in a location below the point of inflection as shown in FIG. 42.

FIG. 44a schematically shows the shape of a rectangular tube preform with extra glass on the sides of the tube as it is being drawn down while in a location above the point of inflection as shown in FIG. 42.

FIG. 44b schematically shows the shape of a rectangular tube preform where the extra glass on the sides of the tube is pulling the adjacent faces very flat as it is being drawn down while in a location below the point of inflection as shown in FIG. 42.

FIG. 45a shows a plasma tube being sealed closed using a gas flame.

FIG. 45b shows a plasma tube that has been sealed where there is a bend in the seal area.

FIG. 46 shows a plasma tube where the end to the tube is back filled with a polymer or silicone solution to strengthen the end of the tube.

FIG. 47 shows a tube array connected to an electroded sheet with a film on the back side of the tube array to help protect the tubes.

FIG. 48 shows a printed circuit board with driver chips and an edge connector where each output of the driver chip is electrically connected to a recessed plated slot on the side of the circuit board.

FIG. 49 shows an edge connector formed by an array of plated through holes that have been cut open during the board separation process.

FIG. 50 shows an array of plasma tubes where the wire electrodes are extended out of the array and connected to the electronics at a 90 degree angle to the tube array.

FIG. 51 schematically shows a plasma tube with the phosphor coating on the outside of the tube.

FIG. 52 schematically shows a plasma tube filled with phosphor coated glass plasma spheres.

FIG. 53 schematically shows a fiber with phosphor coated glass plasma spheres.

FIG. 54 schematically shows two orthogonal electroded sheets sandwiched around a plane of plasma spheres.

FIG. 55 schematically shows a plasma tube where grooves have been deformed into one of the surfaces.

FIG. 56 schematically shows a tubular plasma display composed of an array of plasma tubes with an attached array of wire electrodes, where the wire electrodes are placed in v-grooves pressed into the surface of the plasma tubes.

FIG. 57 schematically shows a cross-section of a plasma tube containing a lens on the surface of the tube and two individual plasma chambers inside the tube.

FIG. 58 schematically shows a cross-section of a plasma tube containing a Fresnel-based lens on the surface of the tube and two individual plasma chambers inside the tube.

FIG. 59 schematically shows a cross-section of a plasma tube containing two different lenses on the surface of the tube which are aligned to two individual plasma chambers inside the tube.

FIG. 60 schematically shows an electroded sheet with a lenticular lens embossed in the surface.

FIG. 61 schematically shows an electroded sheet with alternating convex and concave lenses embossed into the surface.

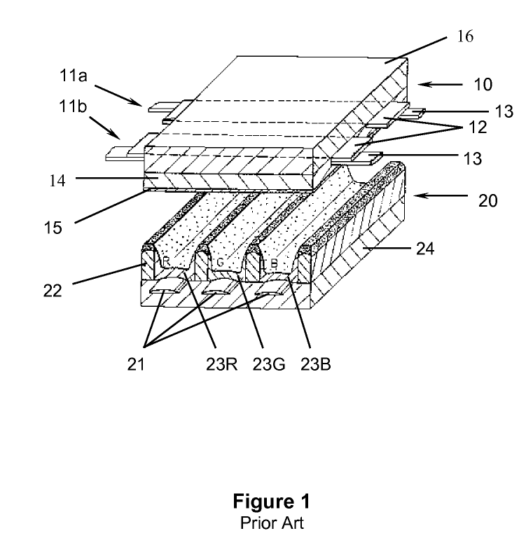

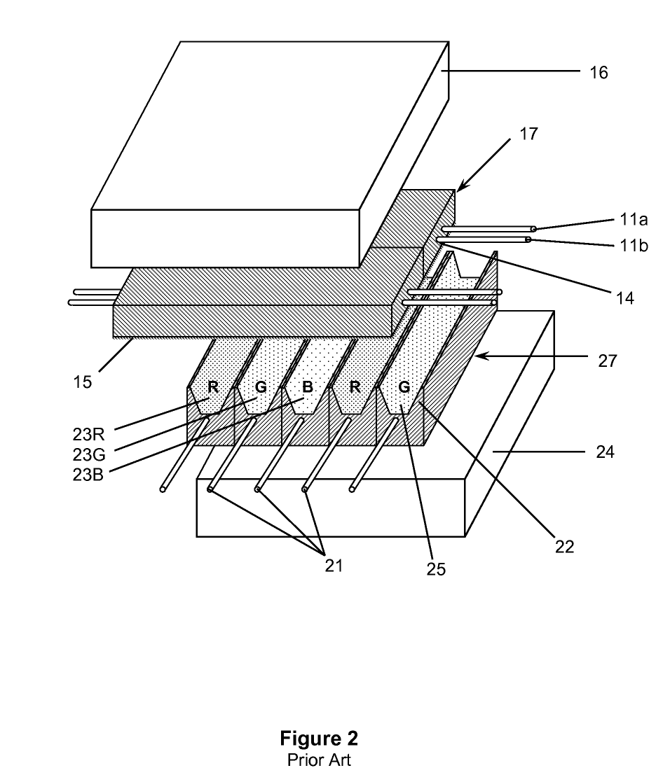

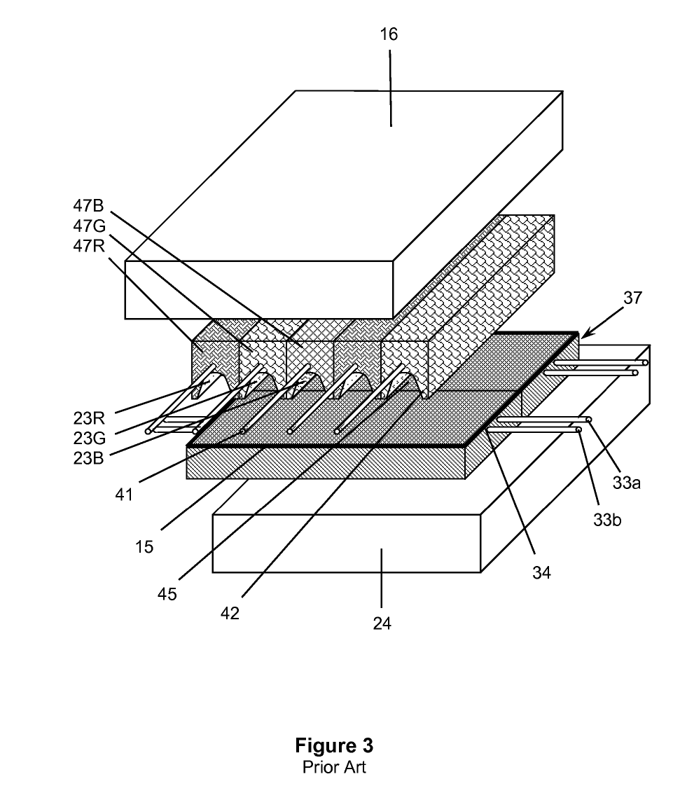

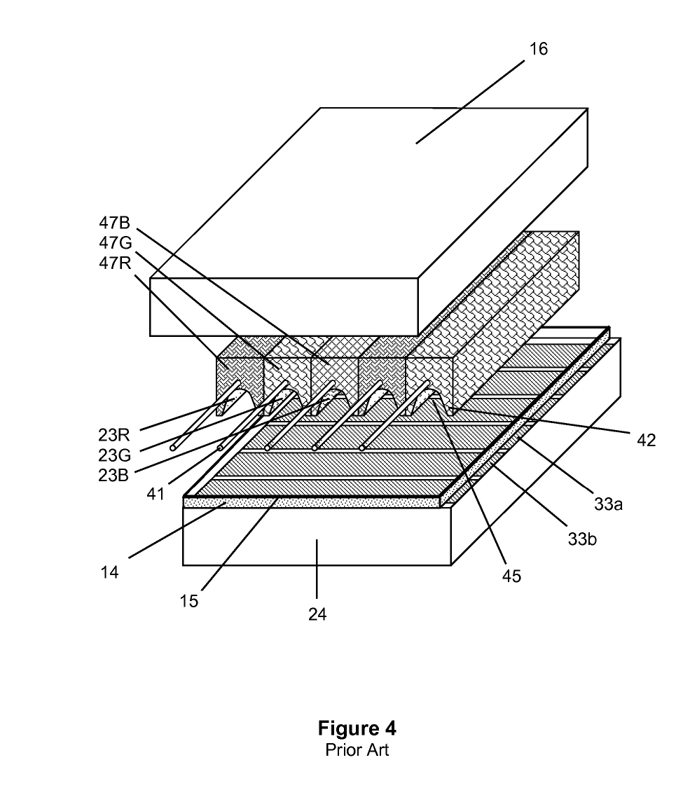

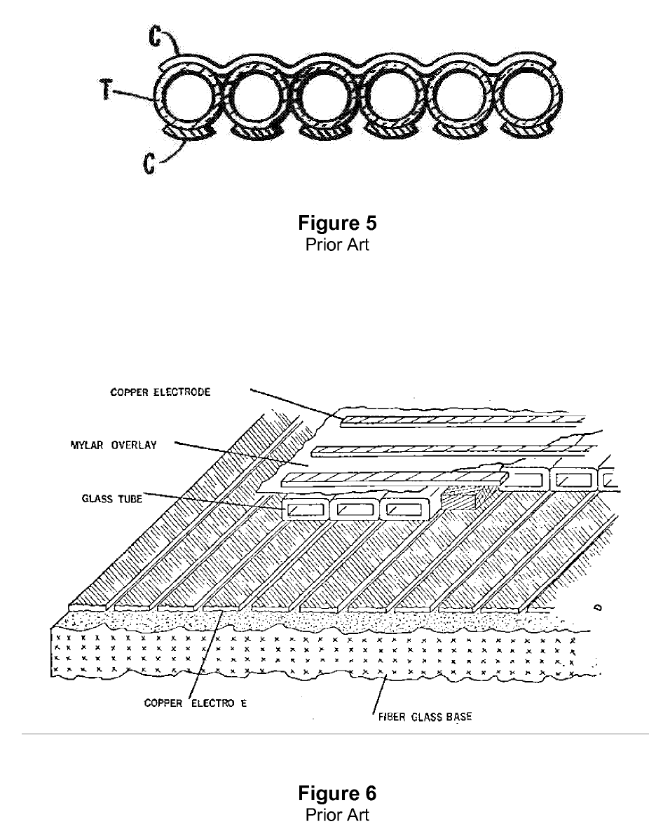

### DETAILED DESCRIPTION OF THE INVENTION

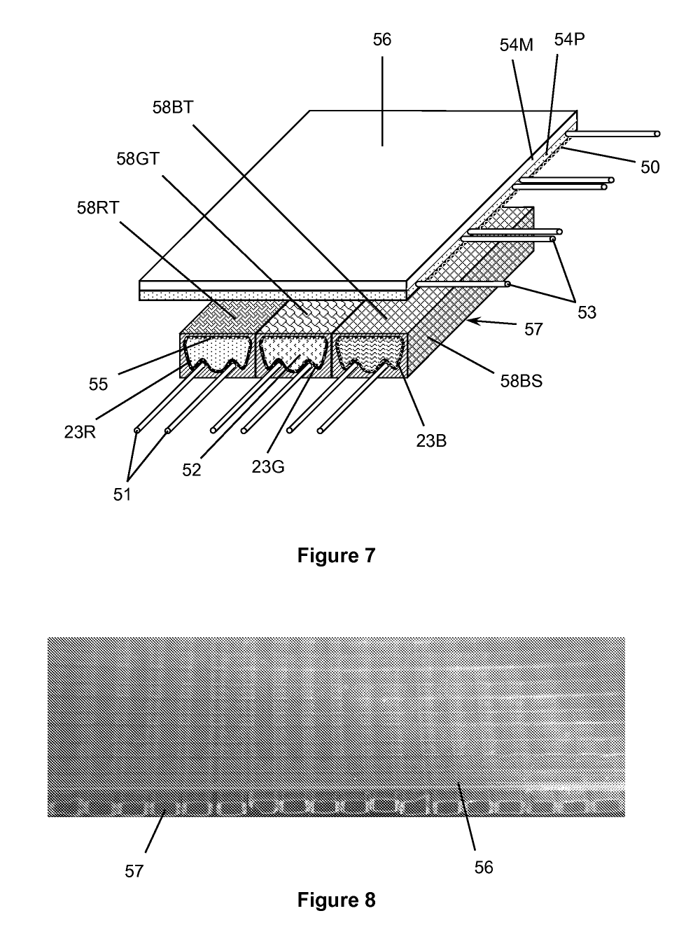

In one embodiment of the present invention, a tubular plasma display (TPD) includes an electroded sheet (eSheet) attached to an array of plasma tubes, as shown in FIG. 7. The electroded sheet 56 is a polymer substrate 54 containing wire electrodes 53. The plasma tubes 57 contain wire electrodes 51, a hard emissive coating 55, a phosphorescent material 23 and a plasma gas capable of generating ultraviolet light. Color filter coatings 58RT, 58GT, 58BT are added to the top of the plasma tube 57 and a black matrix 58BS is added to the sides of the plasma tubes 57. The electroded sheet 56 is directly bonded to the array of plasma tubes 57, where the wire sustain electrodes 53 in the electroded sheet 56 are nominally orthogonal to the wire address electrodes 51 in the plasma tubes 57. Using wire electrodes in both the electroded sheet 56 and the tubes 57 allows for low cost manufacturing and high quality operation of very large plasma displays. The wire electrodes are preferably composed of materials that have high electrical conductivities and have a large diameter (0.002″ to 0.005″), which gives them a relatively large cross-sectional area. These two key traits lead to highly conductive lines and the capability of addressing very long lengths or very large displays (>500″ diagonal).

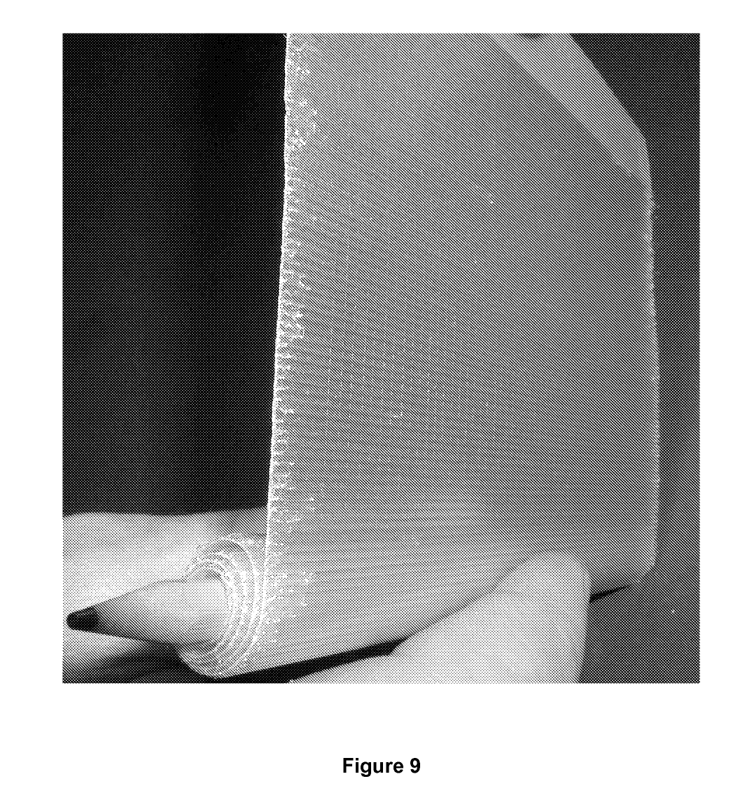

The plasma tube array 57 is preferably connected directly to the electroded sheet 56, as shown in FIG. 8. In this example, contact adhesive is used to attach the tube array 57 to the electroded sheet 56. The only part of the tube array 57 that is attached to the electroded sheet 56 is the top surface of the tube. Only attaching the top surface of the tube 57 to the electroded sheet creates a very flexible and rollable panel orthogonal to the tube direction. FIG. 9 shows a tubular plasma display containing a tube array 57 connected to an electroded sheet that is rolled around a pencil. In this image the tubes 57 are not coated with a phosphor layer nor are the electrodes connected to electronics to better show the way the tubes roll. Since the tubes are composed of borosilicate glass (Pyrex®) they may be sealed closed and a monochrome display using a neon-base gas may be fabricated. The total height of the plasma tubes 57 only have to be slightly higher than the depth of the plasma channel 52 and the electroded sheet 56 base polymer substrate 54 only needs to be slightly thicker than the diameter of the wire electrodes 53, therefore the overall thickness of the panel may be as thin as 0.5 mm. The cross-sectional volume of glass in the tubes 57 is relatively low since most of the tube volume is plasma gas. This low glass volume and thin electroded sheet means that a 100″ diagonal tubular plasma display panel weighs less than 3 pounds.

A tubular plasma display may be designed to be addressed using most of the waveforms traditionally used in the industry for AC plasma displays. Tubular plasma displays may be addressed using both erase addressing (explained in U.S. Pat. No. 5,446,344, herein incorporated by reference) and write addressing (explained in U.S. Pat. No. 5,661,500, herein incorporated by reference). To increase the dark room contrast of the panel, a ramped voltage may be used to set the initial charge conditions in the panel (explained in U.S. Pat. No. 5,745,086, herein incorporated by reference). In order to cut the number of addressable lines in half during each video frame an interlaced addressing scheme may be used similar to that explained in U.S. Pat. No. 5,436,634, herein incorporated by reference. In fact, since the largest market for these tubular plasma displays is home television and the new US high-definition standard is 1080i then it makes the most sense to design these tubular plasma displays to operate in an interlaced mode of addressing.

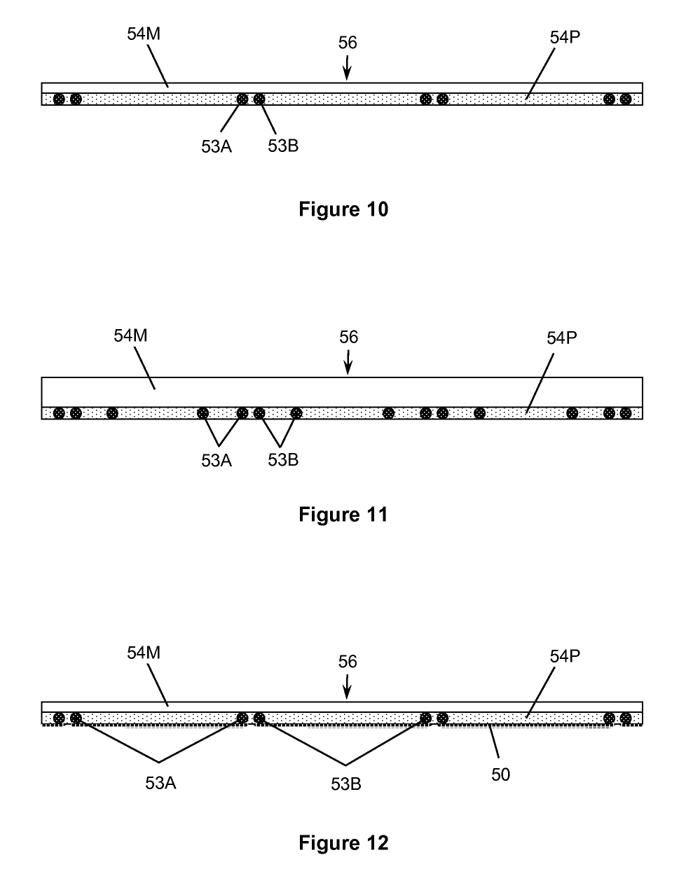

FIG. 10 shows a cross-sectional view of an electroded sheet 56 normal to the wire electrodes 53. Wire electrodes 53 are used to carry the capacitive current along the length of the electroded sheet or the display. In most plasma panel configurations these wire electrodes 53 are in pairs 53A and 53B and are referred to as sustain electrodes. In order for the electroded sheet 56 to be attached to the plasma tubes 57, the wire electrodes 53 have to be embedded into the polymer surface so they do not add pressure points on the tube array and crack the tubes. However, the wire electrodes 53 should not be embedded far below the surface of the polymer substrate 54 or the voltages required to address and sustain the plasma will be increased and the variability in the voltage will be difficult to control.

Using wires as the electrodes in the panel has several advantages. First, the wires are preferably formed from a metal with a high conductivity, like copper, and that compounded with a large cross-sectional area of the electrode allows for a very conductive electrode. Conductive electrodes are necessary when creating very large displays to keep the RC time constant low enough to be able to reliable address and sustain long electrode lines. Second, the wire electrodes are manufactured in a separate high temperature process to produce spools of highly conductive wire that may be subsequently added to a low temperature polymer substrate. Therefore, an electroded sheet is formed with highly conductive metal electrode lines in a low temperature polymer substrate. Third, the electroded sheets may be manufactured in very large sizes. Polymer sheets are presently manufactured in over 20 feet wide continuous rolls. Fourth, the cost of creating the electroded sheets is very low. Polymer substrates used in the electroded sheets discussed in this application cost between $0.05/sqft to $0.30/sqft and the fine wire in the electroded sheets costs between $1/km to $5/km. This results in an electroded sheet cost between $0.50/sqft to $2.50/sqft. One major cost advantage over the traditional methods of creating a substrate with electrodes is that the electroded sheet process does not require any metal deposition, vacuum depositions, patterning or etching. The traditional deposit, pattern and etch processes are also limited in substrate size until the expensive processing equipment is developed, purchased and operational. Fifth, using a very flexible wire embedded in a very flexible polymer substrate results in a very flexible, rugged, rollable electroded sheet. Whereas, traditional metal coatings deposited on a polymer substrate that is repeatably flexed and rolled tends to break-up. Sixth, circular wires in the electroded sheet tend to scatter light coming out of the tubular plasma display, whereas a flat patterned metal electrode reflects most of the incident light back into the panel. Therefore, using wire electrodes leads to a brighter display. Seventh, there are many options when connecting the wire electrodes to the drive electronics. The wire may be attached, via soldering, directly to a printed circuit board. Since the wires in the electroded sheet are on a predefined pitch, an edge connector may easily and economically be plugged into the wire array and soldered for a strong electrical bond. The wires may also be partially unzipped from the polymer film and fanned in or out for more options on connecting to the electronics. The partially unzipped wires may also be bent at a 90 degree angle and connected to the drive electronics orthogonal to the major wire direction. This 90 degree wire connection scheme allows all the electronics to be placed on a single edge of the display.

The wire electrodes 53 in the electroded sheet 56 may be embedded in many different types of polymer films 54. The lowest cost and most readily available films are thin polycarbonate and PET (polyethylene terephthalate) films. Silicone substrates or films 54 may alternatively be used; however they are much more expensive and the wire electrodes 53 have to be formed into the silicone films 54 in the gel form. A thin polymer film that is much easier to embed the wire electrodes into is a thermal overlaminate, like polyolefin 54P on PET 54M. In these thermal overlaminates the wire electrodes 53 may be embedded in the polyolefin section 54P of the film at a relatively low temperature (˜100° C.). In addition, these low cost thermal laminates may be supplied with a textured PET surface, which serves as an antireflective surface. The polyolefin surface also serves as an adhesive layer. The polyolefin surface is traditionally designed to be very tacky at its softening point and bonds very strongly to the plasma tubes 57. The polyolefin 54P on PET 54M sheet is very tough and durable. The film stack has been designed to be UV stable and the PET surface is very chemically stable. Antiscratch surface coatings may also be applied to the PET surface. The electroded sheet's 56 polymer substrate 54 may alternatively be composed of a reflective white material or an absorptive black material; however the light has to be transmitted out of the opposite side of the tube array 57.

The wire electrodes 53 may be imbedded into the polymer substrate 54 using many different processes. The wires may be pressed into the polymer surface using a roller or plate or may be pulled through a die. Another method of placing the wires into the polymer surface without touching the polymer surface is to place the polymer sheet on a drum and wrap the wires onto the surface of the polymer sheet. Upon heating the drum the polymer surface softens and the wires are pulled into the polymer film as the drum expands. Imbedding the wires in a polyolefin film on PET during this drum embedding process provides a “backstop” for the wire electrodes. Using a polyolefin film thickness equal to the wire diameter places the wires into the polyolefin and they are level with the electroded sheet surface. This stressed wire imbedding on a drum also works using an arced plate. If the electroded sheet is only composed of a polymer substrate containing wire electrodes then the wire electrodes do not have to be exposed to the surface of the electroded sheet. In this case, the wires may be formed directly into the polymer film using a polymer/wire draw process or they may be placed on a polymer substrate and overcoated with a second polymer film or they could be laminated between two polymer films. The laminating adhesive film used to attach the electroded sheet to the tube array also covers the wire electrodes. In this adhesive over laminating process, it is advantageous for the wires to be protruding out of the surface, however the wires should protrude less than the thickness of the adhesive over laminate. The wire will get embedded into the adhesive layer and be located closer to the plasma tubes in the final display panel, leading to lower addressing and sustaining voltages. In one example, the wire electrode in the electroded sheet protrudes less than 25 μm out of the electroded sheet and the wire electrode in the electroded sheet is less than 75 μm deep into the polymer substrate. Several other methods of forming wire electroded sheets are known and the above examples are only intended to illustrate the principle of applying wires to a polymer film to create an electroded sheet.

In some instances it is desirable to have a flattened electroded sheet 56 to connect to the plasma tube array 57. Since the surface of the polymer sheet is moldable it may be flattened by pressing it against a flat plate at an elevated temperature. The flattening process preferably has to be preformed under a vacuum (below about 200 mTorr) in order to get the entire surface flat with no trapped air pockets. The “grooves” around the embedded wire electrodes help during this flattening process to supply channels for the air to escape from the electroded sheet/flattening plate interface. If a flattening plate is used to produce a flattened surface, then either a vacuum bagging process or a vacuum pressing process is desired. In order for the electroded sheet to be released from the flattening plate after the flattening process step, a release film will need to be applied to the flattening plate. One of the best release films for most polymer substrates is a thin silicone coating. This silicone coating may be applied to a polymer film, like PET, and the silicone coated PET film may be placed between the electroded sheet and a ridged flat plate or the silicone film may be applied directly to the ridged flat plate. A flat silicone coated glass release plate has the advantage that it may be reused several times to keep the flattening cost low. The surface of the electroded sheet may also be flattened by running a very smooth roller across the surface.

FIG. 11 shows an electroded sheet 56 that has more than one wire per electrode 53. Using more than one wire per electrode 53 spreads the effect of the electric field from the electrodes 53 into the plasma chamber 52. This spreading of the electric field leads to a spreading of the plasma, hence increasing the luminous and luminous efficiency of the plasma and lowering the voltages. Another method of spreading the extent of the electric field from the wire electrode 53 is to connect a transparent conductive electrode (TCE) 50 to the wire electrode 53, as shown in FIG. 12. The wire electrode 53 carries the bulk of the current along the length of the line and the TCE 50 spreads the voltage across the width of pixels in the line.

FIG. 12 shows a web of TCE 50 between two wire electrodes 53A or 53B. In a surface discharge plasma display the gap between the wire electrodes 53A and 53B controls the initial firing of the plasma. Therefore, the gap between adjacent wire electrodes 53A and 53B must be uniform across the entire electroded sheet 56. Using a TCE 50 web between a pair of wire electrodes 53 has manufacturing advantages in that there are two anchoring lines to electrically connect the wire 53 to the TCE 50. The plasma voltage is applied to both sides of the TCE 50, leading to a more uniform voltage across the TCE 50 and along the length of the entire electrode. In addition, having two anchoring lines helps keep the TCE 50 connected to the wire electrodes 53 over the lifetime of the product. Another advantage of using a webbed TCE 50 between wires is to keep adjacent electrode lines 53A and 54B electrically isolated from each other. During the manufacturing of an electroded sheet 56, the electrode stripes, composing the TCE 50 connected to the wire electrodes 53, have to be electrically isolated from each other. Invariably small shorts exist between the electrode stripes as a result of flakes of TCE shorting the masked area between electrode stripes. The easiest and most efficient method of removing these shorts is to apply a voltage between adjacent electrode stripes, in turn burning out the TCE short and obtaining electrically isolated electrode stripes. Having adjacent pairs of highly conductive wires to apply the voltage across leads to the highest probability of only removing, via burning out, the shorts in the electroded sheet.

In order for the panel to be rollable, the transparent conductive electrode 50 has to be formed out of a material that will not break-up when the polymer substrate 54 is bent. Some acceptable coatings include, but are not limited to, a transparent conductive polymer, like Baytron, or a coating formed using conductive nanotubes or nanorods, like carbon nanotubes. It could be very beneficial to use a combination of conductive polymer and nanotubes, therefore if the conductive polymer forms islands the nanotubes will bridge these islands and electrically connect them together. Both of these coatings form a transparent conductive film that is very rugged and do not become electrically disconnected when stressed as a result of rolling or bending of the electroded sheet.

If a TCE coating 50 is used in the electroded sheet 56, then a double-sided adhesive may be used to bond the electroded sheet 56 to the plasma tubes 57. This double-sided adhesive also protects the TCE 50 from getting rubbed against the plasma tubes 57 while the panel is being flexed or rolled.

Most of these processes discussed above to form the electroded sheet are explained in more detail in U.S. provisional patent applications 60/749,446, entitled “Electrode Addressing Plane in an Electronic Display”, filed Dec. 12, 2005, 60/759,704, entitled “Electrode Addressing Plane in an Electronic Display and Process”, filed Jan. 18, 2006, and 60/827,152, entitled “Electroded Sheet”, filed on Sep. 27, 2006, which are all included herein by reference.

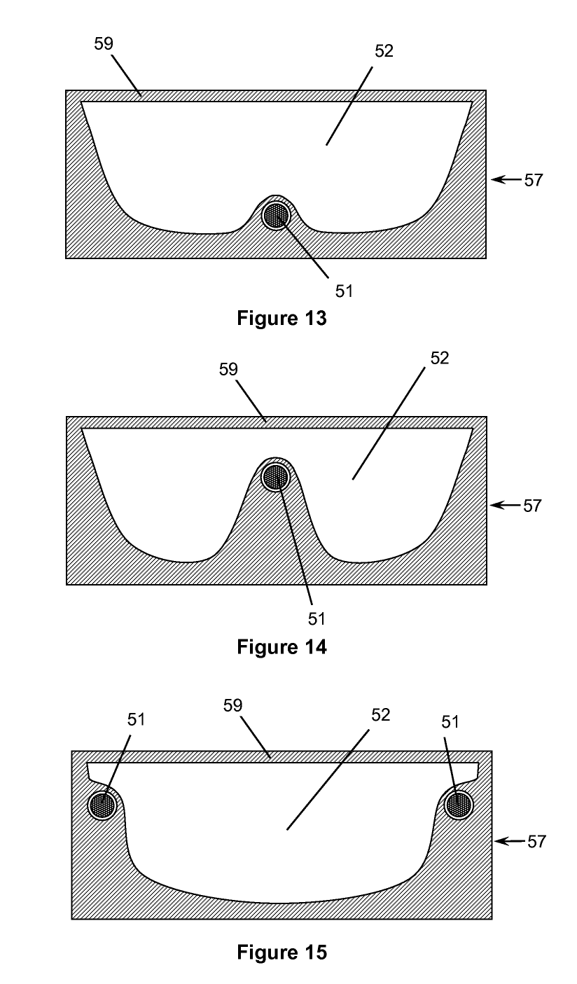

FIG. 13 schematically shows a cross-section of a plasma tube 57 containing a wire electrode 51. If the plasma tube 57 is used in a surface discharge plasma display the wire electrode 51 is used as an address electrode, whereas if the tube 57 is used as a two electrode plasma display panel, the wire electrode 51 is used as one of the sustain electrodes. The plasma tube 57 has a plasma chamber 52 that is evacuated and backfilled with a plasma gas. For monochrome panels, this plasma gas is traditionally composed mainly of Neon, whereas for color panels the plasma gas usually contains Xenon to generate ultraviolet radiation. The top surface 59 of the plasma tube 57 is a thin fairly uniform glass wall 59 such that minimal electric field is dropped across it. This surface 59 is the part of the plasma tube 57 that is attached to the electroded sheet 56 to form the tubular plasma display. Very large displays may be manufactured using the tubular structure. In fact, a plasma has been ignited in a plasma tube over 6 football fields long.

The wire electrode 51 containing plasma tubes 57 are preferably formed using a fiber or tube draw process, sometime referred to as a redraw process. The wire electrodes 51 are included into the plasma tubes 57 during the tube draw. Wire from a spool is threaded through “tunnels” or wire guides in the preform. As glass tube 57 is drawn, the wire guide decreases in size and pulls the wire into the tube from the spool of wire attached above the preform. The tube containing the wire electrode is drawn and spooled onto a large diameter drum. The tubes are removed from the drum as tube arrays for subsequent processing. The preforms in which the tubes are drawn from are preferably formed using hot glass extrusion or may be drawn from a tank melt through a die.

FIG. 14 depicts a structure where the wire electrode 51 is positioned inside the plasma tube 57 close to the sustaining surface 59 of the plasma tube 57. In a surface discharge plasma display, moving the address electrode closer to the sustaining electrodes 53 lowers the required addressing voltage and speeds up the addressing time. One problem with this structure (FIG. 14) is that the wire address electrode 51 is in the center of the plasma cell 52, which has an effect on the electric field from the sustain electrodes 53. FIG. 15 shows a tube 57 structure that moves the address electrode 51 into the sides of the tube walls. Moving the wire electrodes 51 to the sides of the tube 57 provides a large unobtrusive gas volume for uniform plasma firing. Placing the wire address electrodes 51 near the top also shortens the addressing distance in turn lowering the addressing voltage and speeding up the addressing time. Having a small gas gap between the wire electrodes 51 and the top of the plasma tube 59 provides the electric field an open space to reliably address the pixel.

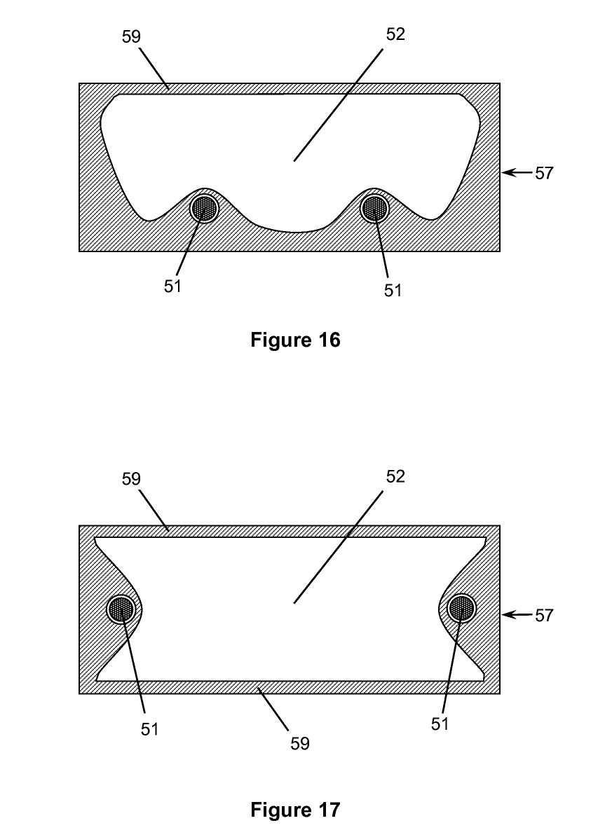

FIG. 16 shows a plasma tube 57 with two wire electrodes 51 at the bottom of the plasma channel 52. Spacing two wire electrodes 51 at the bottom of the plasma channel 52 increases the effective width of the address electrode, which leads to faster more uniform addressing of the plasma.

In FIG. 17 the wire electrodes 51 are placed in the center of the plasma tube 57 side walls. In this case, there are two thin glass wall surfaces 59 such that either side may be attached to the electroded sheet 56. Creating a tube with two thin walls 59 and thicker side walls has advantages in pulling the surfaces 59 of the tube 57 flat during the tube draw process, as discussed below.

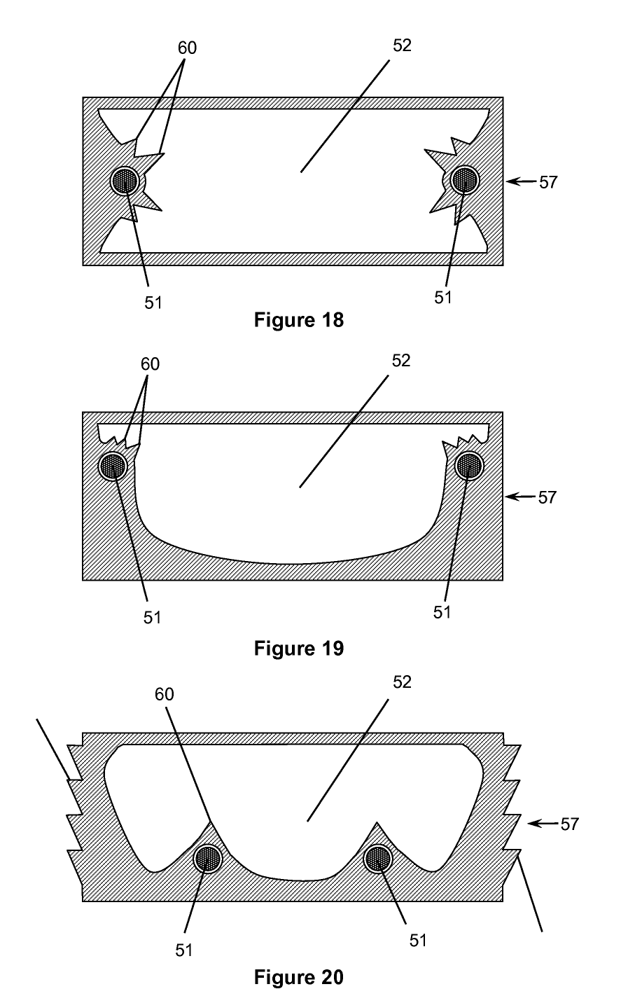

FIGS. 18-20 show different plasma tube 57 structures with texture 60 around the wire electrodes 51. The addition of intrapixel shape 60 around the wires 51 assists in firing the plasma in the plasma chamber 52. The electric field strength is higher in the glass spikes around the wire electrode 51 since the tube's glass has a higher dielectric constant than the gas. Depending on the shape of the plasma tube 57 and the structure of the texture 60 around the wire electrodes 51, the effect of a concentrated electric field could lower the addressing, firing or sustaining voltages required to operate the display. In addition, the addressing speed, as well as the luminance and luminance efficiency, may be increased.

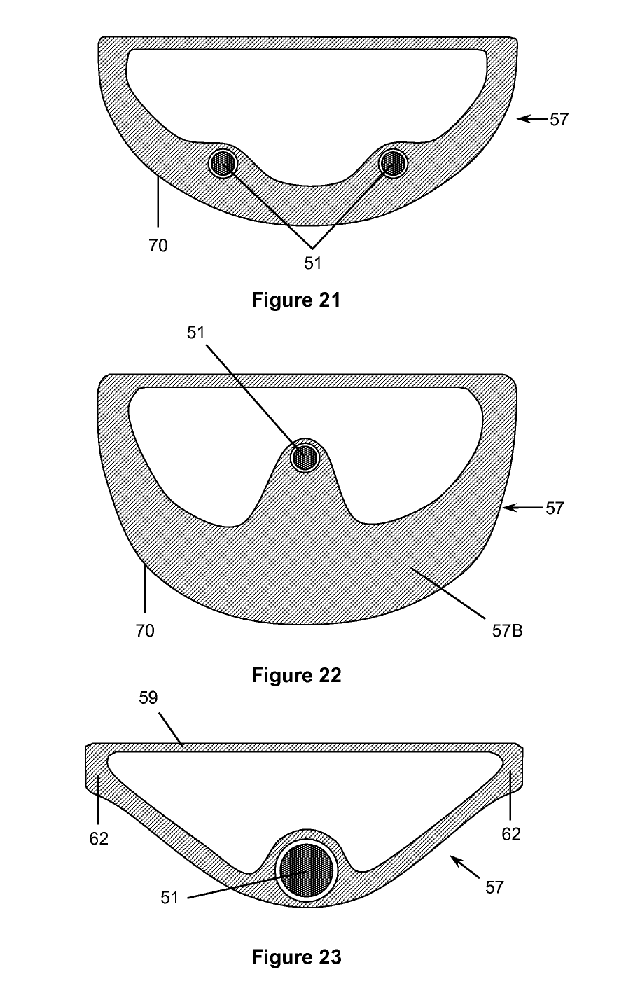

FIG. 20 also shows structure 61 on the outside of the tube 57. This structure 61 on the outside walls of the plasma tubes 57 may be used to scatter or redirect light coming from the plasma tube out toward the viewer. Coating the bottom sides of the triangular shapes with a reflective coating will increase the efficiency of the light redirecting structure 61.

FIG. 21 shows a plasma tube 57 with rounded sides and bottom 70. Rounding the sides and bottom 70 of the tubes 57 in the tube array/panel/display creates a panel with more flexibility. First, the panel is able to be bent/rolled slightly away from the electroded sheet or opposite to the easy rolling direction since there is a recess on the sides of the tubes. Second, rounding the corners 70 of the tube 57 makes it much stronger and more flexible when bent along the tube direction. Third, adjacent tubes 57 do not come into hard contact along the entire edge of the tube 57 when the panel is rolled/unrolled. Therefore, the stress applied to the tubes during usage is minimized. In addition, if any particulates get between the tubes they do not form a contact point and break a tube. Fourth, a round tube bottom and flat tube top help when assembling the display. When assembling the tube array, if a tube 57 is flipped over, the tube 57 is easily noticed because it rolls and the flat surface has a noticeably different reflection than the rounded tube surface.

FIG. 22 shows a tube structure 57 with a much thicker glass base 57B. Designing a tube with a thick base 57B and thick side walls with a curved base 70 creates a much stronger tube that has a much higher crush resistance. Having rounded edges on both the inside and outside tube corners, such as those traditionally obtained using hot glass extrusion or tank drawn preforms also has a dramatic effect on the strength of the final glass tubes 57. Another method to strengthen the glass tubes is to apply a coating to the tube surface. This coating could be a color filter coating as discussed below or it could be a surface modification film. These surface coatings help protect the surface from scratches, which tends to weaken the glass tubes.

FIG. 23 shows a tube structure 57 with minimal glass volume, which leads to a very light weight tube array. The electrode 51 is shown to be much larger than in the other figures, showing that either a much larger wire electrode 51 may be used or the image is magnified and the tube is much smaller than in the other figures. In order to obtain a flat surface in the thin top layer 59 extra glass has to be added to the sides of the tube 62 in order to pull the thin glass surface 59 flat during the fiber draw. These thicker glass regions 62 may also be composed of a stiffer glass or a glass with a lower viscosity. The effects on the draw forces on the shape of the tube are explained below.

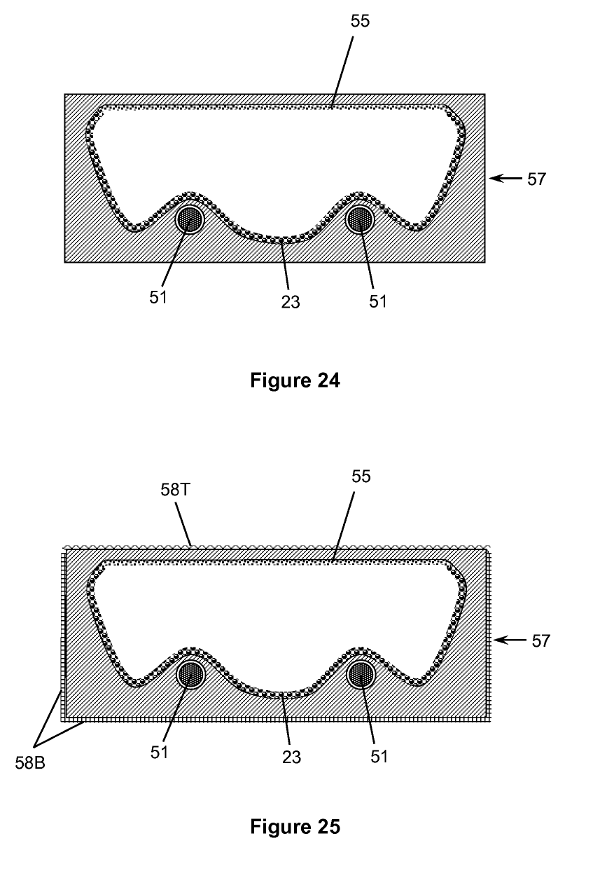

FIG. 24 shows a plasma tube 57 containing wire address electrodes 51 with a hard emissive coating 55 on the inside top surface and a phosphor coating 23 on the other inner tube surfaces. In order to create a color display, at least three different color phosphor coated tubes are required. Traditionally, the three primary color phosphors used are red, green and blue. Therefore, arraying a panel with . . . RGB . . . phosphor filled tubes and controlling the amount of light generated at each pixel along the length of the tubes creates a full color image. To create a plasma display with higher quality images the different color tubes may be different widths. The relative width of one of the color tubes may be increased to compensate for the lower luminance of the one of the colors (usually blue) or to increase luminance or brightness of a particular color, like green, since the human eye is more sensitive to green, a wider green pixels will have the appearance of a brighter display.

To stop any phosphor ion damage the phosphors could also be placed on the outside of the plasma tubes. However, the walls of the plasma tubes would have to be transparent to the UV generated inside the tubes. Most glass compositions that have fairly high UV transmissions, like silica, also have very high melting and forming temperatures and usually have a fairly large network and are not pervious to some of the preferred plasma gas mixtures, such as Helium. Placing the phosphors on the outside of the plasma tube would also make the gas processing and sealing of the plasma tubes easier since a hermetic seal would be easier without phosphors in the seal area.

The hard emissive coating could be a traditional magnesium oxide, MgO, like in traditional plasma displays or could be a different material, like strontium oxide, or a combination of several different metal oxides or metal fluoride components. The hard emissive coating is used to reduce the amount of sputtering of the glass surface that the plasma is being fired against and also serves as a secondary electron emissive coating. A traditional method of coating the tubes with ebeam evaporation or sputtering is virtually not possible for small long plasma tubes. Therefore, a solution coating or chemical vapor deposition, CVD, coating is required. Solution coating, such as magnesium acetate, magnesium methoxyethoxide or strontium isopropoxide, may be coated on the inner tube walls and then pyrolized to form a MgO or SrO containing emissive coating. The solution coating may alternatively be formed using a nanopowder of a hard emissive coating, like MgO, SrO, CaO, etc., mixed into a vehicle, like amyl acetate. The vehicle could also contain a pyrolizable solution like discussed above. Therefore, a MgO powder could be mixed with a strontium isopropoxide solution to form a compound hard emissive coating. When the strontium isopropoxide in the vehicle is pyrolized it will bond the MgO powder together and attach it to the inner surface of the plasma tubes.

The phosphor and hard emissive coatings could be coated after the tubes 57 are formed using an off-line coating process. The coatings may be simply flushed through the plasma tubes to create a film on the inside surface of the tubes. Heat may be applied to the coating to assist in evaporating some of the solvent to create a thicker coating. The coatings could also be pulled though the tube to deposit a layer on the inner tube surface. A powder coating could also be blown through the tube and coated on the tube walls. Electrostatics could be used to attract the powder to one or more of the surfaces. Also, one or more of the surfaces could be coated with an adhesive layer to hold onto the powder. A settling process could also be used to coat one or more surfaces. In this case, the phosphor or hard emissive powder would be mixed in a vehicle and placed into the tubes. The tubes would then be placed in a horizontal position so the powder may settle. The liquid vehicle may then be slowly decanted from the tubes so as not to disturb the powder coating. To create a thicker film the coating solution may be repeatedly coated inside the tube. A drying step may be required between each coat.

After the plasma tubes are coated with a hard emissive coating and a phosphor layer they are gas processed. There are several methods of gas processing the plasma tubes. The easiest and most manufacturable is to connect the ends of the plasma tubes to a gas tight manifold. An epoxy may be used to create a vacuum tight manifold seal around the ends of the tube array and the manifold may be attached to a vacuum system. The tube array may then be hung in a furnace to heat the tubes during the evacuation process. Proper design of the system allows the epoxy manifold to only be slightly above room temperature as the tube array is raised to several hundreds of degrees Celsius. A vacuum manifold may be placed on both ends of the tube array or may be placed on one end and the other end of the tubes may be sealed closed. After the temperature of the tubes is elevated under a high vacuum they may be backfilled with the plasma gas and the ends of the tubes near the gas manifold may be sealed closed. The tubes may be sealed closed using a gas torch or a hot bar may be placed against the surface of the tubes to seal them closed. Each tube is individually sealed closed containing its own plasma gas. If it is desired, the red, green, and blue phosphor coated tubes may contain different gases at different pressures, which can be optimized to the particular plasma tube geometry and color phosphor coating of that tube. However, the sustain voltage and margin of all the tubes used in a panel will have to be similar in order for the display to be properly addressed and operated.

A plasma may be ignited inside the plasma tubes to assist in the gas processing step. The simplest method of igniting a plasma inside the tubes is to place the tube array between two metal electrodes and apply an AC voltage to the metal electrodes. An oxygen or fluorine based gas may be ignited inside the tubes to help clean and remove any carbon contamination inside the tubes. A dual electrode sustainer plate may be used in order to minimize the ion damage on the phosphor layer. This dual electrode sustainer plate should be placed against the tube surface containing the MgO layer. This sustainer plate could have interleaved cathode and anode electrodes. In order to spread the ion bombardment across the entire inside surface of the plasma tubes it is necessary to translate the sustainer plate along the length of the tube. The sustainer plate may be in a form of a plate or a roller. It is also advantageous if the sustainer plate is composed of a metal foil on a soft backing so not to crush or crack any of the plasma tubes when pressed against the tube array.

FIG. 25 shows that a color filter 58 may be applied to the outside of the plasma tubes to increase the bright room contrast and the color purity of the panel. One of the only image quality specifications that LCDs have over PDPs is bright room contrast. That is because there is no easy way to economically add a color filter to a plasma display. The last steps in a PDP panel manufacturing process are high temperature frit seal and gas processing steps. These process steps are performed at about 350° C., which is too high a temperature for any of the low cost high quality polymer color filter materials. However, when a plasma display is manufactured using plasma tubes, color filter films 58 may be applied to the surface of the tubes after they have been gas processed and sealed. Assuming that the tube in FIG. 25 has a green phosphor material 23 deposited inside the plasma tube 57 then a color filter film 58T may be applied to the top of the plasma tube 57 that transmits green, but absorbs red and blue light. The bottom and sides of the plasma tube 57 may be coated with a different color filter 58B that reflects green light, but absorbs red and blue. The top color filter film 58T allows the green phosphor generated light to escape out the top of the plasma tube 57, but absorbs any red or blue light incident on the tube, in turn enhancing the bright room contrast of that tube. The color filter coated bottom and sides 58B reflect the green phosphor 23 generated light back into the tube, such that it escapes out of the top side of the tube and absorbs any red and blue light leaking through the top color filter or coming from an adjacent tube. This bottom and side color filter 58B increases the brightness and contrast of the display. To increase the brightness even further the color filter 58B may be solely coated on the bottom of the plasma tube 57 and the sides may be left bare. Similar examples can be explained for the tubes that have red and blue phosphor coatings. In addition, black coatings may be added to the sides and bottom of the plasma tubes to enhance the contrast of the display. Black coated tube sides also serve a black matrix function to better define the pixel. The color coating may be applied to the tubes by pulling the tubes across a coating head, the tubes can be dip coated by submerging them into a colored solution, or a color film can be sprayed onto the tube surface.

A contact adhesive may be used to attach the tube array to the surface of electroded sheet. Using a pressure sensitive contact adhesive bonds the tube array containing the polymer color filter coatings 58 to the electroded sheet at room temperature. This final low temperature assembly step does not cause any color shift in the color filter. The contact adhesive may be initially applied to the electroded sheet and when bonded to the tube array forms a very strong bond to the tubes. A strong bond is advantageous when rolling and handling the panel and help protect the color filter material from rubbing off. The contact adhesive removes any pressure points due to the wire electrodes in the electroded sheet or small particles on the plasma tubes, thus creating a more rugged panel.

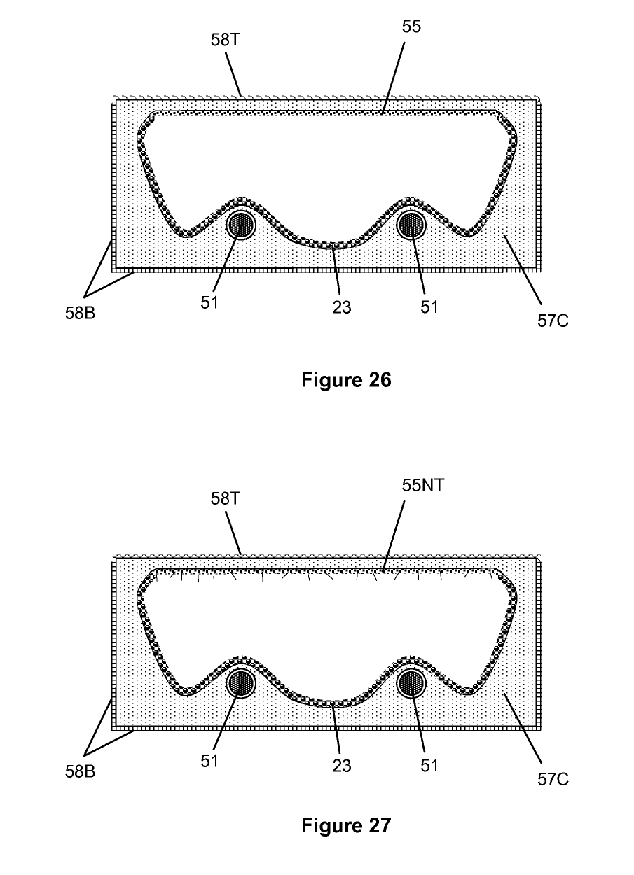

FIG. 26 shows that colored glass could be used to form the plasma tube 57C, which adds a color filter to the plasma tube. It would also be beneficial if the glass used to form the plasma tube 57 reflects the ultraviolet light, UV, generated by the plasma gas, but transmits the photoluminescent visible light from the phosphor. The options for glass that reflect UV and transmit visible light are very limited. They will have to be in the form of a phase separated glass or glass ceramic with the size of the internal particles very small and a tight distribution. The major surface requiring UV reflection is a surface with the hard emissive coating, like MgO. A UV reflective surface could be obtained in the coating used to form this hard emissive coating. If a coating of nanoparticles is used with the correct UV reflectivity, then most of the UV light incident on this surface may be scattered back into the plasma tube, thus increasing the brightness of the display. In some embodiments, to obtain the optimum UV reflectivity a mixture of different nanoparticles with different dielectric constants, like MgO and SrO or CaO or MgF₂ or CaF₂, may have to be used.

FIG. 27 shows a colored glass plasma tube 57C with its corresponding color phosphor coating 23, color filters on the top 58T, and color filter on sides and bottom 58B. The plasma tube has a hard emissive coating containing nanotubes, nanorods or nanoparticles 55NT on the top sustaining surface. Adding nanotubes to the MgO coating 55NT has at least two benefits. First, the nanotubes or nanoparticles act as small storage capacitors inside the plasma tubes. These small charge storage islands help in addressing the subpixels inside the panel. Having the capability to store more charge at each subpixel increases the voltage margin of the panel. An increased voltage margin allows for faster addressing and more options for cell structure, gas composition and voltage waveforms. Secondly, since nanotubes have a very low electron emission voltage (typically ˜2 V/μm), they serve as electron emitters during sustaining, in turn, increasing the brightness of the display.

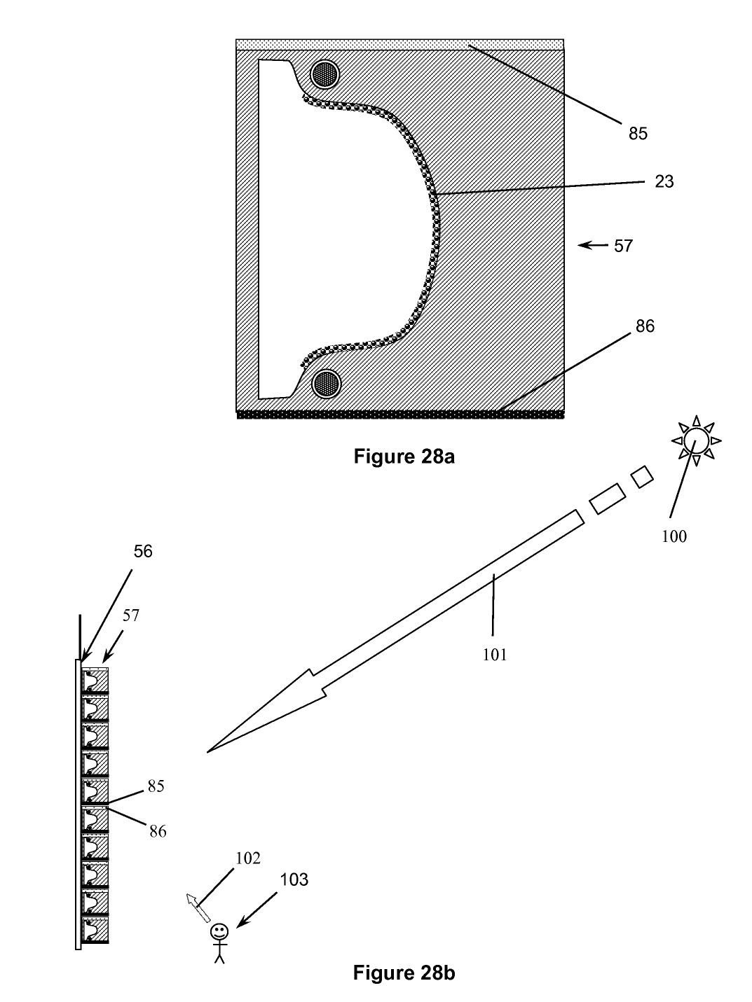

FIG. 28 shows another embodiment of the invention where a black absorbing coating 86 is added to the side of the tube 57 to act as a visor during outdoor applications to block the sunlight 101 shining into the panel from the sun 100. The phosphor material 23 in the plasma tube 57 is very white and reflective in natural sunlight 101, therefore the sun blocking visor 86 blocks the sunlight 101 shining on the phosphor coating 23. This visor methodology is used in the Light Emitting Diode (LED) industry for outdoor electronic signs and is also used in traffic lights to remove the light reflecting on the light bulbs. However, in the traditional flat panel industry where the structure is built-up on the panel, it is difficult to achieve depth or height of an absorbing layer required to shadow the pixel from the sun 100. Using a light blocking visor structure 85 similar to that shown in FIG. 28a requires a tube height, h=w/tan(α)−c, where w is the width of the pixel, c is the depth of the phosphor channel and α is the angle of the sun with respect to the horizon. If a display has a pixel pitch of 1 mm with a 0.2 mm deep channel and the sun is very low on the horizon (30 degrees) then the height of the tube has to be 1.93 mm to block all the sun shining onto the phosphor. However, if a tube 57 is designed to block light as low as 30 degrees then the viewing angle from below is also 30 degrees and a greater percentage of the emitted light gets blocked as the viewer moves off the vertical axis of the display. FIG. 28 also shows adding a reflective layer 85 to the other side of the tube 57. If the tubes 57 are arrayed in a panel similar to that shown in FIG. 28b, then sunlight 101 shining on the tube array 57 from above the normal of the display gets absorbed by the sun blocking visor 86 reducing the amount of light incident on the reflective phosphors. However, a viewer 103 standing below the normal of the panel will observe 102 the white reflecting layer 85 part of the tube 57, which will reflect light generated by the phosphors toward the viewer 103. The concept of using a black absorbing layer to serve as a visor to block the sunlight in a wire containing fiber was first disclosed in U.S. patent application Ser. No. 11/236,904, entitled “Electrode Enhancements for Fiber-Based Displays”, filed Sep. 28, 2005, incorporated herein by reference.

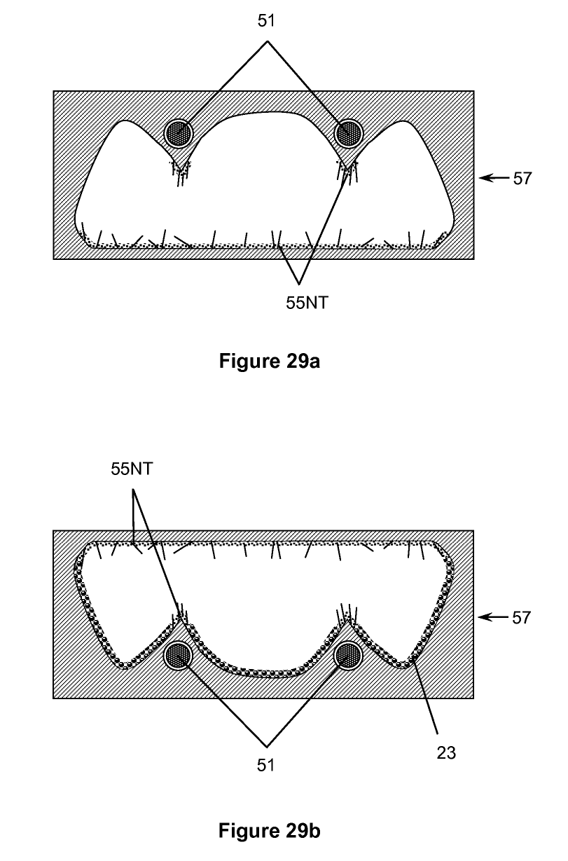

FIG. 29 shows a method of coating a plasma tube 57 with a hard emissive coating containing nanotubes 55NT then coating it with a phosphor coating 23. FIG. 29a is a cross-section of a plasma tube 57 filled with a MgO/nanotube solution. The solution is allowed to settle to form a coating 55NT. Coating a plasma tube 57 with structure around the wire address electrodes 51 places an MgO/nanotube coating 55NT on both the thin walled glass surface and on the tips around the address electrodes 51 after settling. If the plasma tube 57 is filled with phosphor 23 and allowed to settle toward the opposite surface then a phosphor coating may be settled onto the remaining surfaces, as shown in FIG. 29b.

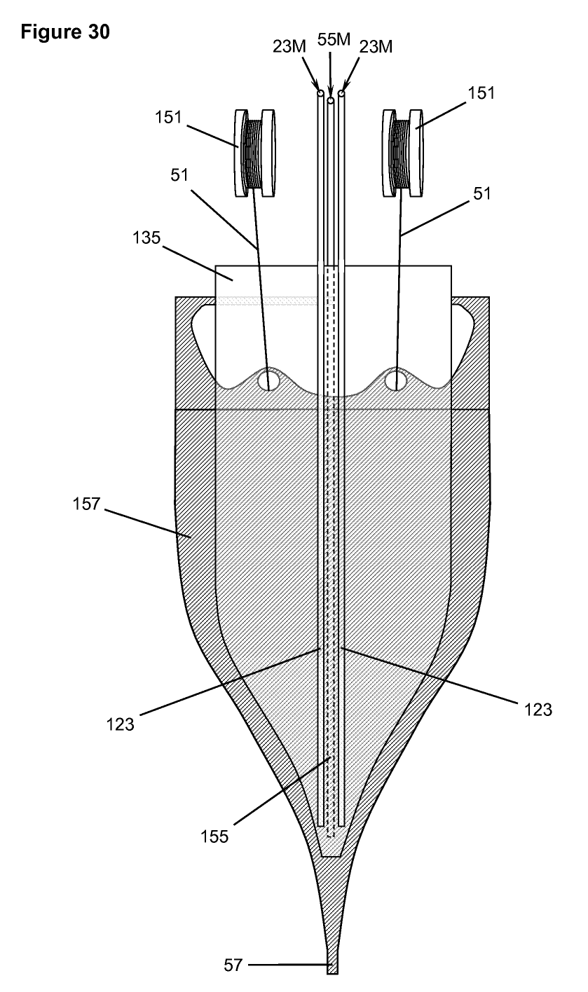

As explained above, there are many methods of coating the insides of the plasma tubes 57 with a hard emissive coating 55 and a phosphor layer 23. FIG. 30 shows a method of applying these coatings during the tube draw process. It is not possible to simply deposit the phosphor on the inner tube preform 157 wall and draw it into the tube 57, since most glass tube materials require a high temperature tube draw (˜1,000° C.). If the phosphor material is at an elevated temperature for too long, its luminous efficiency degrades. Therefore, the only way to apply the phosphor coating during the tube draw process is to deliver the material deep down into the root of the draw. Small delivery tubes 123 may be placed into the preforms during the tube draw to carry the phosphor material 23M into the tubes. A carrier gas, preferably oxygen, mixed with the phosphor material 23M is fed into the carrier tubes 123 and is delivered down into the root of the draw. A high flow rate down the delivery tubes 123 causes minimal heating of the phosphor material. Delivering the phosphor material 23 deep into the root of the draw means the phosphor material 23M will only be at the draw temperature until the tube is drawn out of the bottom of the furnace and cooled to room temperature. The carrier gas can escape out of the top of the tube and if composed of oxygen can help clean any carbon contamination. Likewise, the MgO material 55M may also be delivered into the root of the draw through a small tube 155 using a carrier gas. A separator plate 135 may be used to keep the phosphor and MgO depositions on their perspective sides. The delivery tubes 123 and 155 may be attached to the separation plate 135 and they have to be held at a fixed location relative to the furnace or the root of the draw. The separation plate 135 has to be tapered at the bottom to follow the contour of the root of the preform in order to extend down into the root and keep the phosphor and MgO coatings separate and on their perspective inner plasma tube walls. Wire electrodes 51 from wire spools 151 can be co-drawn in to the tubes during this on the draw coating process.

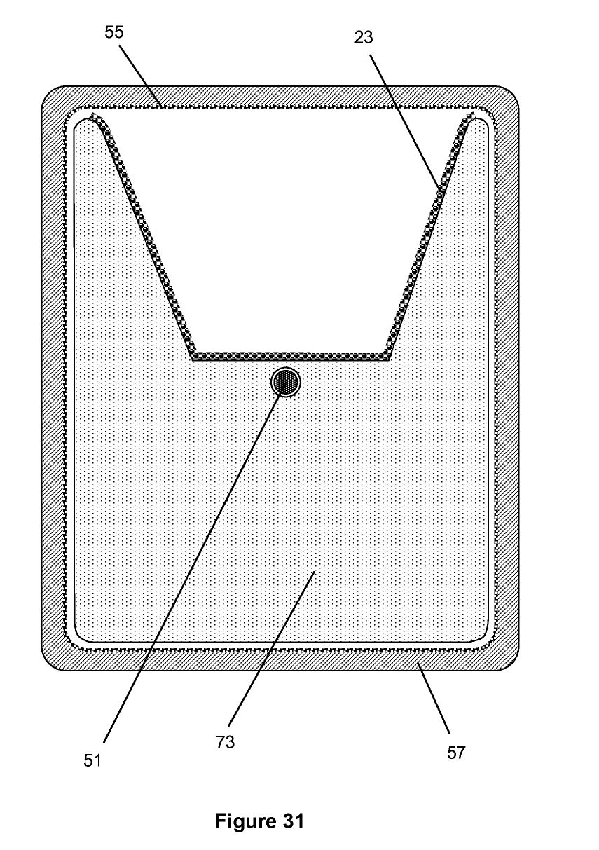

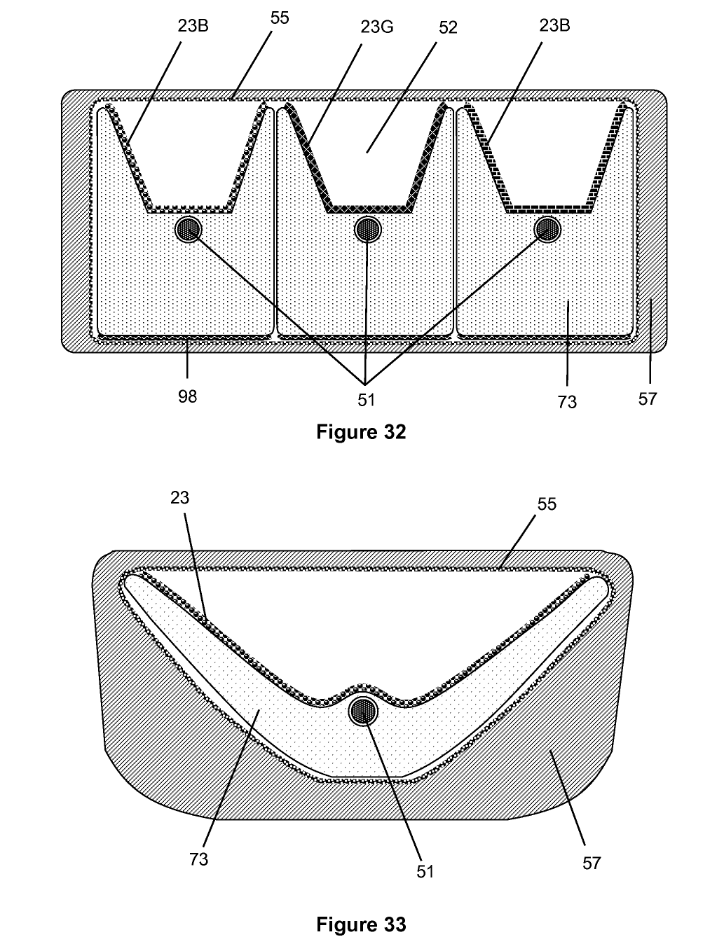

FIG. 31 shows another embodiment of the present invention where a fiber 73 containing a wire electrode 51 and a phosphor coating 23 is drawn into a hollow tube 57 containing a hard emissive coating 55. The fiber 73 containing a wire address electrode 51 may be drawn in a fiber draw process on a drum and coated with phosphor 23 off-line then unwound and drawn into the plasma tube 57 in a subsequent tube draw process. The hard emissive coating 55 may be applied to the surface of the plasma tube preform 157 and then drawn into the small tube diameter 57 or may be fed into the plasma tube down a small delivery tube similar to that explained above in FIG. 30. If the hard emissive coating 55 is applied during the tube draw process then it is advantageous to feed the phosphor 23 coated fiber 73 down a guide tube into the root of the tube draw to keep the MgO 55 from depositing on the phosphor layer 23. The advantage of coating a wire electroded 51 fiber 73 with a phosphor coating 23 off-line is that a simple spraying process may be used to phosphor coat the fiber 73. A phosphor coating 23 deposited using a spraying process creates a very uniform phosphor coating 23 on the plasma channel in the fiber 73. In addition, when the fiber 73 is drawn into the tube 55, the fiber 73 will only see the elevated temperature for a very short period of time since it is moving through the root at the tube draw speed. This short elevated temperature has minimal degradation on the phosphor coating 23. Since it is not required that the fiber 73 and tube 55 are fused together during the tube draw process they may be composed of different glass compositions. The tube 55 may be composed of a colored glass that matches the color of the phosphor coating 23 and the fiber 73 could be composed of a white opal glass to reflect the light generated by the phosphor layer 23 trying to escape out of the bottom or sides of the fiber/tube.

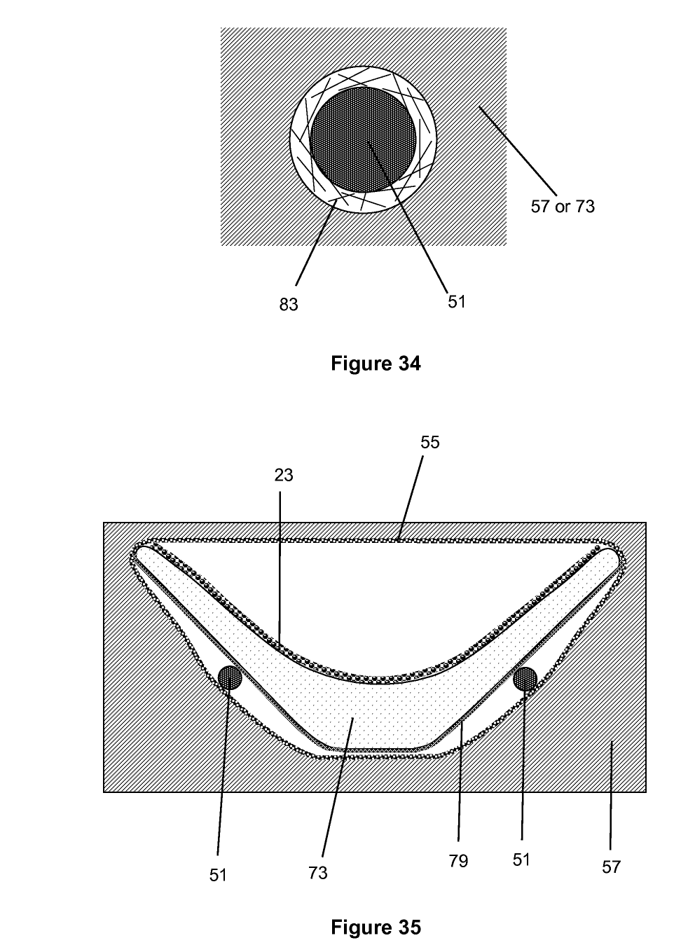

FIG. 32 shows three fibers 73 drawn into a single plasma tube 57. Each of the three fibers 73 may be coated with red 23R, green 23G and blue 23B phosphor layers. To help control the contamination inside the tubes, the bottom of the fibers 73 is preferably coated with a getter 98. The getter 98 is not in the plasma generation area 52 and minimizes the contamination in the plasma tubes, hence keeping a low plasma firing voltage over the life of the display. The plasma gas gettering material 98 may also be coated on the bottom of the plasma tube 57. Coating the getter material 98 in a form that can be compacted helps keep the fibers 73 tight against the top of the tube 57 surface. The fibers 73 have to be relatively tight against the tube 57 at the top surface to keep electrons and ions from leaking over the top side of the plasma channels 52 forming fiber walls to eliminate any cross-talk and misaddressing if more than one fiber 73 is added per tube 57.

FIG. 33 shows a winged-shaped fiber 73 containing a wire address electrode 51 and a phosphor coating 23 with a much smaller amount of glass in the base. The phosphor 23 coated fiber 73 is drawn into a plasma tube 57 with a rounded bottom and thicker side walls to increase the strength of the tube 57. Other different shaped phosphor 23 coated fibers 73 with wire electrodes 51 may alternatively be drawn into the plasma tubes 57 to form a tubular plasma display.

FIG. 34 shows a method of removing any voltage drop between the wire electrode 51 and the glass fiber 73 or tube 57 by coating the wire before or during the draw with a conductive coating 83. The wire electrode 51 is usually drawn taut into the fiber 73 or tube 57, therefore the electrode 51 tends to wander from one surface to the next within the glass tunnel in the fiber 73 or tube 57. This slight air gap will have an effect on the firing or addressing of the plasma along the length of the tube 57 or from tube to tube. To eliminate this air gap, the wire 51 may be coated with carbon nanotubes 83 to keep the wire 51 electrically tight to the glass walls, thus eliminating the capacitive air gap. The conductive coating or filler 83 may be composed of nanotubes, nanorods or other conductive particles. If the conductive filler 83 is composed of metal particles, they may be a lower melting point metal that melts during the draw process to remove any air gaps between the wire 51 and the glass tunnel walls.

FIG. 35 shows another example of using a phosphor 23 coated fiber 73 inside a plasma tube 57. In this example, the phosphor 23 coated fiber 73 has a conductive coating 79 on the back side of the fiber 73. A wire electrode 51 is drawn into the plasma tube 57 and makes contact with the metal coating 79. Therefore, the wire is used to carry the bulk of the current along the length of the tube and the conductive coating 79 is used to spread the voltage around the bottom of the phosphor 23 coated fiber 73. Applying a metal coating 79 to the bottom of the fiber 73 allows for a uniform addressing voltage to be applied along the entire length of the plasma tube 57. If the metal coating 79 is reflective, then it will reflect the phosphor 23 generated light escaping out of the bottom of the tube back toward the viewer. If the conductive coating 79 has a relatively high electrical conductivity then the wire electrode 51 will not have to be in constant contact with the coating 79 along the entire length of the fiber 73.

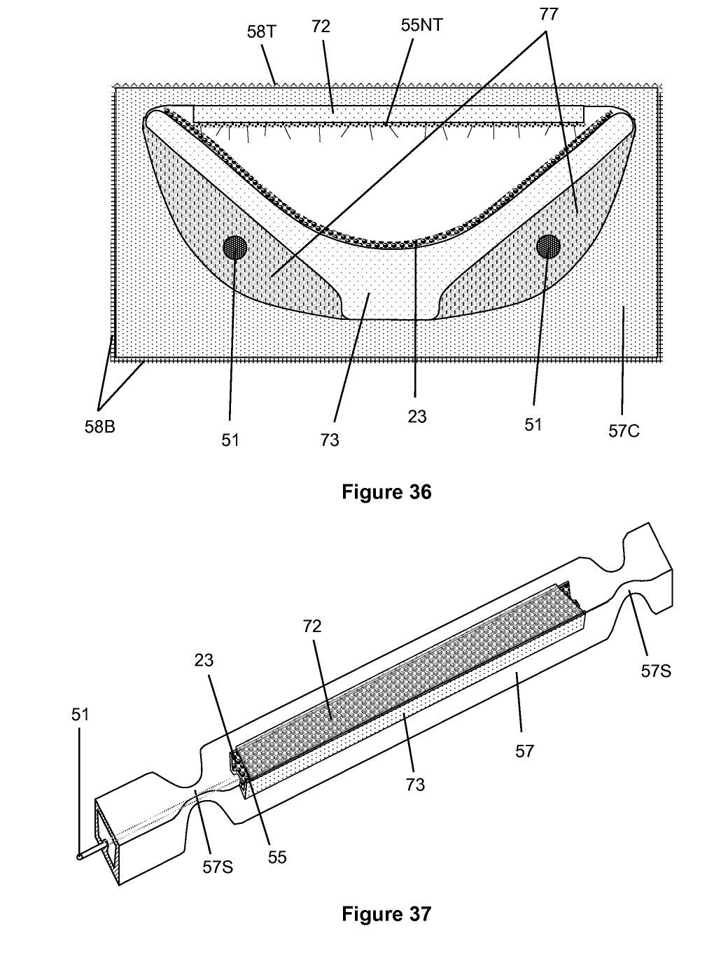

FIG. 36 shows another method of using a phosphor 23 coated fiber 73 inside a plasma tube 57. In this example, wire electrodes 51 are surrounded by a sea of conductive particles 77 and placed between the bottom of the phosphor 23 coated fiber 73 and the plasma tube 57C. The sea of conductive particles 77 makes electrical contact with the wire electrode 51 and spreads the potential from the wire 51 to the bottom surface of the fiber 73. The sea of conductive particles 77 may also have or be composed of a getter material to help keep the plasma gas clean during the lifetime of the display. A second fiber 72 may also be drawn into the tube that houses the hard emissive coating 55NT. In one embodiment, this hard emissive coating 55NT is a MgO coating with nanotubes. FIG. 36 also shows the plasma tube 57C composed of a color glass and containing color filter films 58 as discussed above.

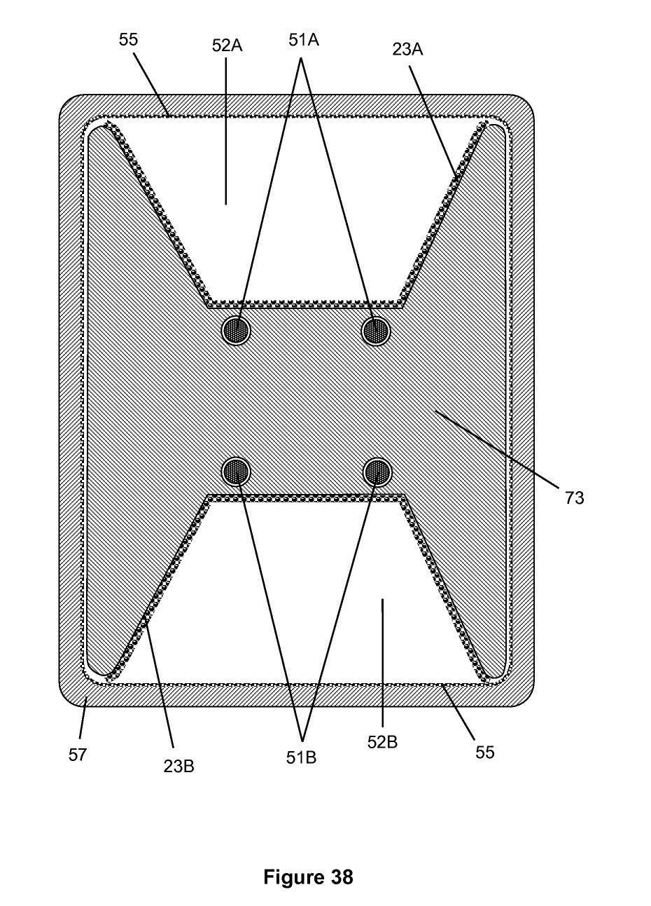

FIG. 37 shows an example where both the phosphor 23 coated fiber 73 and the MgO 55 coated fiber 72 may be placed inside the plasma tube 57 between the vacuum tight seals 57S. Placing all the coatings and additional fibers inside the tube seals 57S provides for a much higher yield when gas processing and sealing 57S the tubes. If the wire electrode 51 is contained in the tube 57, and not the fiber 73, then the vacuum seal 57S is preferably a simple glass seal.

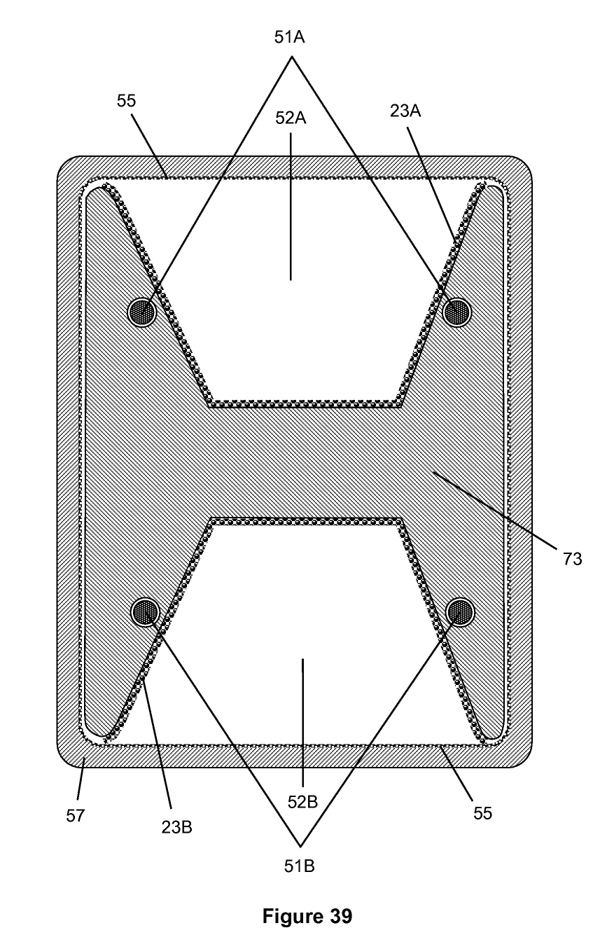

FIG. 38 shows an example of adding a fiber 73 inside a tube 57, where the fiber 73 has plasma channels 52 on opposite sides. This tube 57 fiber 73 structure may be used to create a double-sided tubular plasma display by placing electroded sheets on both sides of the tube array 57. A plasma may be addressed and sustained in the plasma cell region 52A using the wire address electrodes 51A, and a second plasma may be addressed and sustained in the plasma cell region 52B using wire address electrodes 51B. The fiber 73 has to be absorbing or reflecting in order to keep the light generated from the phosphor coating 23A on one side from interfering with the image on the other side of the plasma tube 57 and vice versa. To lower the address voltage, the wire address electrodes 51 may be placed up in the legs of the fiber 73 to be closer to the addressing surface, as shown in FIG. 39, assuming that the tubes 57 are used in a surface discharge type plasma display.

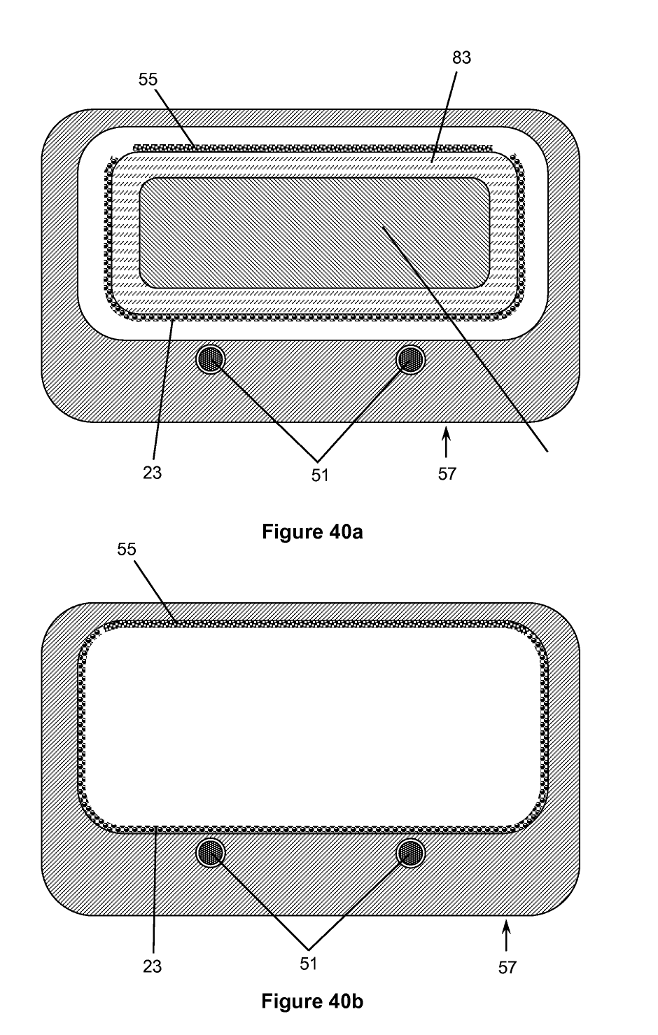

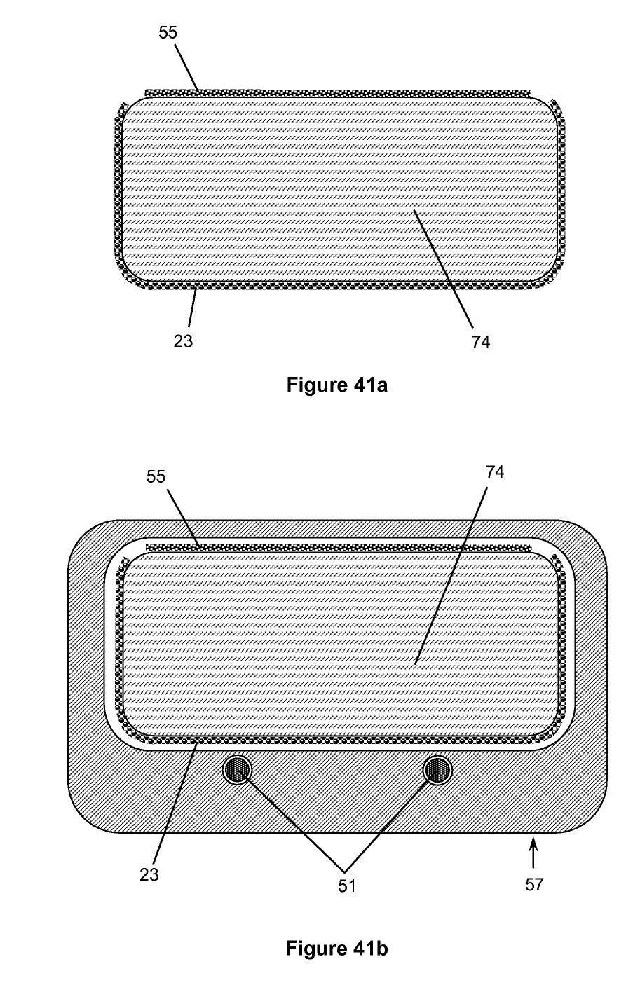

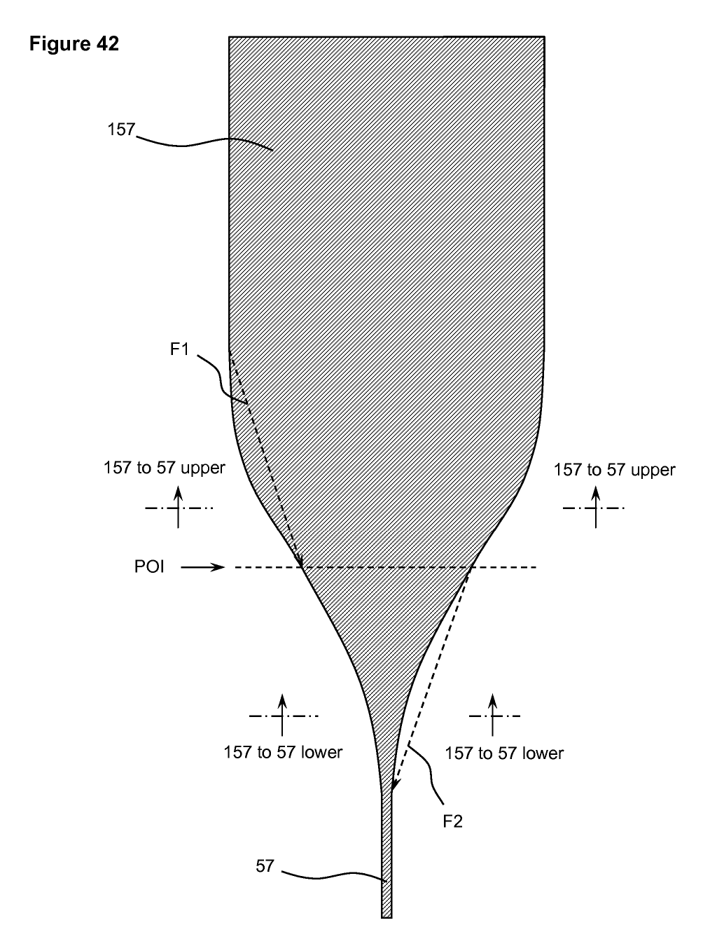

FIG. 40 shows a phosphor 23 and a hard emissive 55 coated fiber 71 used as delivery setters to coat the inside surface of the plasma tube 57 walls. FIG. 40a shows a fiber 71 coated with a release layer 83 that is coated on one side with a MgO layer 55 and a phosphor layer 23 on the other three sides inserted into a plasma tube 57 containing wire electrodes 51. If the release layer 83 may be thermally activated, then, by simply increasing the temperature, the release layer 83 transfers the MgO 55 and phosphor layer 23 to the tube 57 walls, as shown in FIG. 40b. After the transfer to the coating, the fiber setter 71 may be pulled out of the plasma tube 57. A similarly coated tube 57 is achieved where the fiber setter 74 is completely composed of release material, as shown in FIG. 41a. Drawing or inserting this coated release fiber 74 into the plasma tube 57, FIG. 41b, and increasing the temperature creates a coated tube 57 similar to that shown in FIG. 40a without having to manually remove a hard fiber core.

One important part of the tube 57 structure is the flatness and uniformity of the surface of the tube that is fused against the electroded sheet. Firing and addressing the plasma on a flat surface provides a much more uniform voltage along the length of the tube and across the panel. A flat tube 57 surface creates a uniform distance between the wire sustain electrodes in the electroded sheet and the plasma generation region inside the tubes 57. A flat tube surface also provides a better contact area between the tube and the electroded sheet. If the plasma tubes are used in a plasma-addressed electrooptic display, like a plasma-addressed liquid crystal display, then it is imperative to control the flatness of the tube surface. The figures discussed below explain a method of adding additional material to the sides of the plasma tubes to pull the thin surface of the plasma tube flat during the tube draw process.

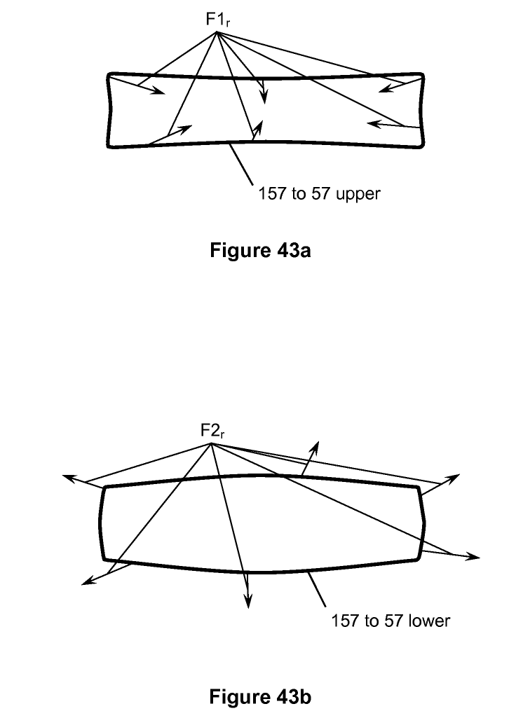

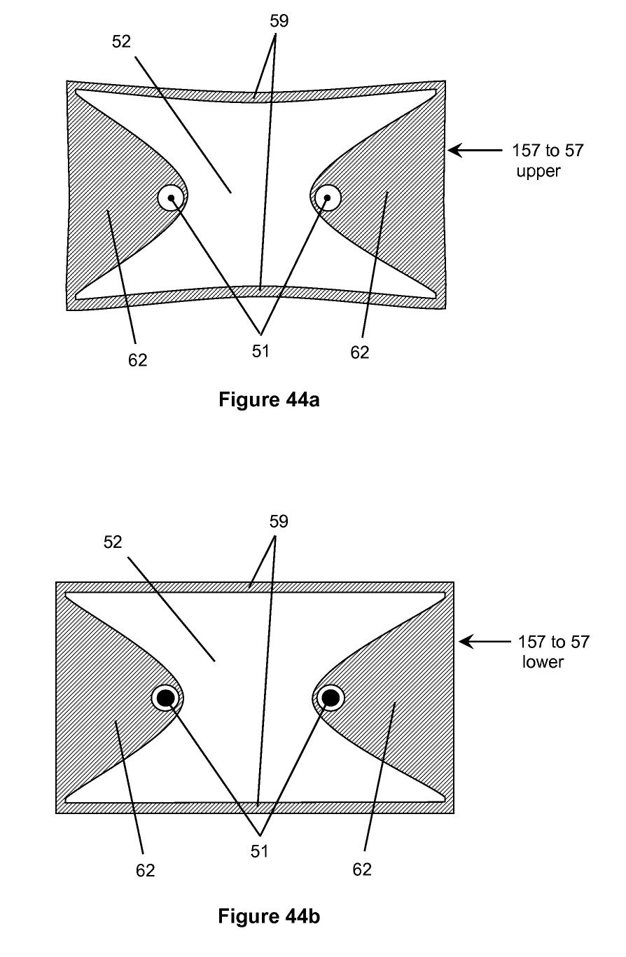

FIG. 42 represents the root of a tube draw or the area that is heated or the area where the preform 157 gets reduced in size or necked down to the size of the tube 57. A relatively constant force is applied to the tube 57 during the tube draw process to continually pull tube 57 from the preform 157. This draw force creates different forces F1 and F2 throughout the root of the tube draw. Above the point of inflection, POI, (the point where the tubes curvature goes from concave to convex) (157 to 57 upper) the downward fiber draw force F1 has a component of the draw force toward the centerline of the root. Below the POI (157 to 57 lower) the downward tube draw force F2 has a component of the draw force away from the centerline of the root. The radial effects of these forces F1 and F2 is depicted in FIGS. 43a and 43b for the drawing of a standard thin walled rectangular tube preform. FIG. 43a is a cross-section of the rectangular tube at a point above the POI (157 to 57 upper) showing that a radial component F1ᵣ exists on the tube forcing the walls of the tube inward or toward the center of mass of the tube. Moving down the root past the POI (157 to 57 lower), the draw force F2 exerts an outward radial component F2ᵣ on the tube away from the center of mass of the tube, as shown in FIG. 43b. This outward force tends to bow the tube out leading to a more circular shape in the drawn tube 57. A small negative pressure may be added to the center of the tube during the tube draw process to hold the rectangular shape of the tube; however it is virtually impossible to keep tight control of the flatness of the tube walls using a vacuum.

FIG. 44 shows a method of adding a larger volume of glass to the sides 62 of the tube 57 than the top and bottom 59 walls to pull the surface of the top and bottom 59 walls flat during the fiber/tube draw process. These large volume sides 62 may also be a stiffer glass or one with a lower viscosity than the thin glass tube walls 59. FIG. 44a shows the top and bottom 59 walls getting pulled in above the POI (157 to 57 upper) where the thicker sides 62 do not change much in shape. The larger glass volume 62 creates a stiffer tube section because of both the larger amount of glass that has to be deformed by the small radial draw force F1 and the fact that the root is being fed into the hot zone and the thicker sections 62 take longer to come up to temperature, therefore, will be at a higher viscosity and will be stiffer. Drawing tube 57 in the tube draw process at the lower temperature range results in a higher draw force because the glass is stiffer or at a higher viscosity. The thicker sides 62 are stiffer than the thin top and bottom 59 walls and below the POI (157 to 57 lower) a larger amount of the draw force F2 is placed on the stiffer thicker sides 62. These stiffer sides 62 will exert an outward force on the thin top and bottom sections 59 and pull them flat. To achieve flat top and bottom walls 59, the draw forces should preferably stay above about approximately one quarter pound for a 1 mm wide tube.

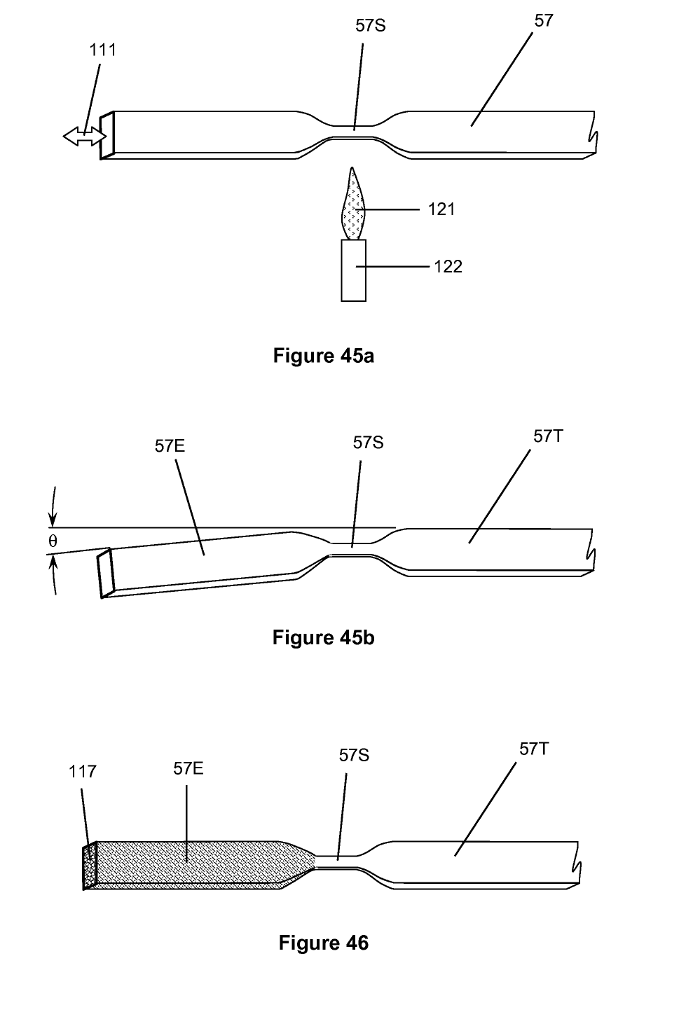

In order to create a rollable tubular plasma display, each tube has to be individually sealed. The gas processing step is shown in FIG. 45a where the tube 57 is evacuated and backfilled 111 with the plasma gas mixture. The tube 57 is then sealed 57S closed using a flame 121 from a torch 122. Other heat sources that could be used to seal the tubes closed 57S include, but are not limited to, a hot bar or a hot rod. One very important part of the tube sealing process step is to create a very straight tube seal 57S. Angles θ as small as 3 degrees between the tube 57T and the end 57E (FIG. 45b) may cause some tube seals 57S to crack and break during the assembly process step and rolling the tubular plasma display. Therefore, it is important to create very straight tube seals 57S with minimal twist. FIG. 46 shows that the ends of the tubes 57E may be filled with a polymer material 117 to strengthen the ends. Filling the tube ends 57E also minimizes the number of particulates when the tubes 57 are cut or broken.

The area around the tube seal may also be coated with a layer to strengthen the seal after the seal is formed. This tube seal strengthening material is applied to the seal area after the seal is formed. It is desired that the strengthening material is placed under tension so the seal glass area is under compression, since glass is strongest under compression. The tube strengthening material may be a hard polymer material, like epoxy, or a silicone material that sets up to form a compression seal.

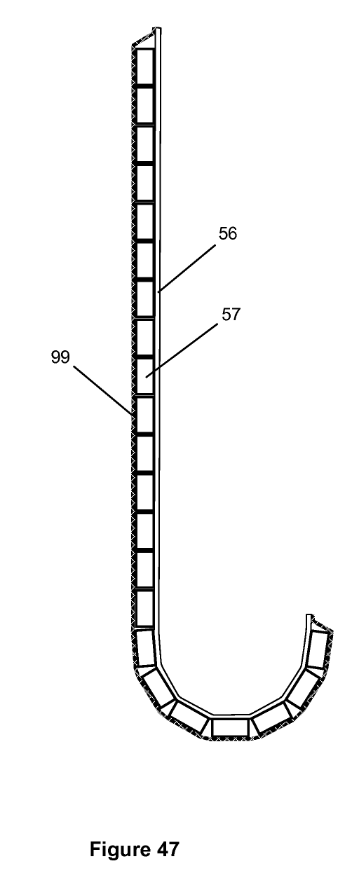

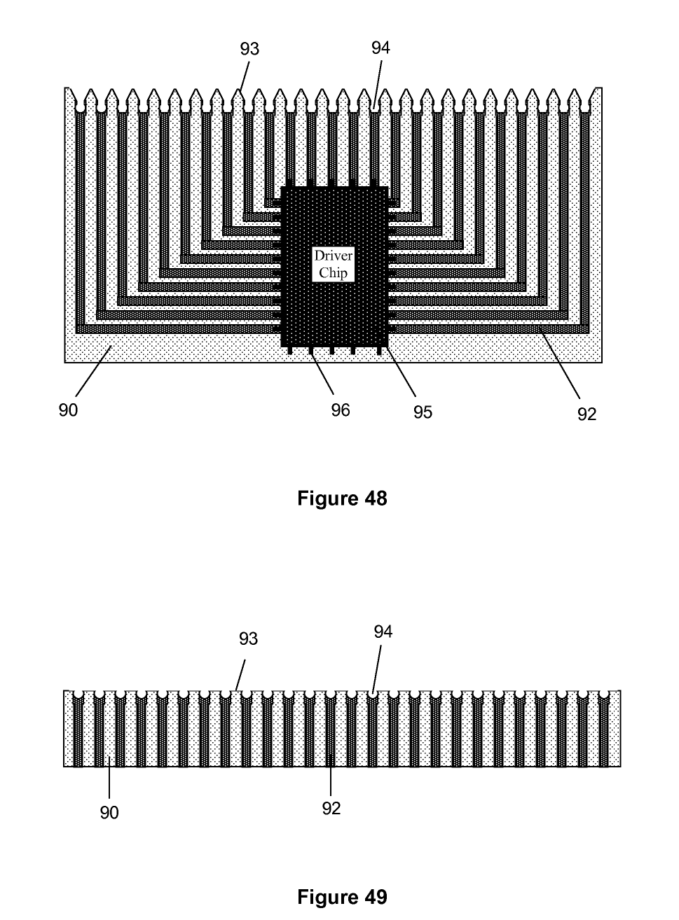

FIG. 47 shows a second, stretchy rubbery sheet 99 that may be added to the back of the tube array 57 that is attached to the electroded sheet 56. The second, stretchy rubbery sheet 99 protects the tubes 57 from any particles getting between the tubes causing them 57 to break when rolling and unrolling. The stretchy sheet 99 helps unroll the tubular plasma display because the sheet 99 gets stretched when it is rolled up and wants to unroll the tubular plasma display. The stretchy rubbery sheet 99 may be formed from an organic polymer material or an inorganic silicone material. The area around the tubes may be filled with a liquid to help: a) remove any reflection if view from the tube side, b) remove any heat from the tubes, or c) lower the frictional forces when rolling and unrolling. The liquid may be a clear, colored or dark fluid and may be water-based with an antifreeze solution to keep it from freezing or can be a polymer-based fluid or silicone oil.

The back side of the tubes may also be coated with a film 57B to reduce the adhesion of particles to the tube surface. The film 57B may be a surface modification film made from a carbon-based solution or a silicone film. The surface modification film also forms a slippery surface that prevents scratching the surface of the tube that form weak sections and cause the tube to crack and also allows the tubes to be rolled and unrolled against each other without scratching them. The surface modification film may also be spongy to cushion the back-side of the tubes.

FIG. 48 shows a printed circuit board 90 containing a driver chip 95 where the output leads are attached to traces 92 in the copper layer that extend to plated out slots 94 in the circuit board 90. After the circuit board is fabricated a laser or waterjet is used to cut in and out of the plated through holes 94 to expose them to the edge of the circuit board 90. Opening up the plated through holes 94 to the outside edge provides an easy port to connect and solder the wire electrodes coming from the tubular plasma display. Cutting in and out of the holes creates pointed ends 93 or a comb-like structure to help guide the wire electrodes into the plated slots 94. To lower the cutting cost of creating the edge connector the printed circuit board 90 may be simply cut straight across the top of the plated through holes 94, as shown in FIG. 49.

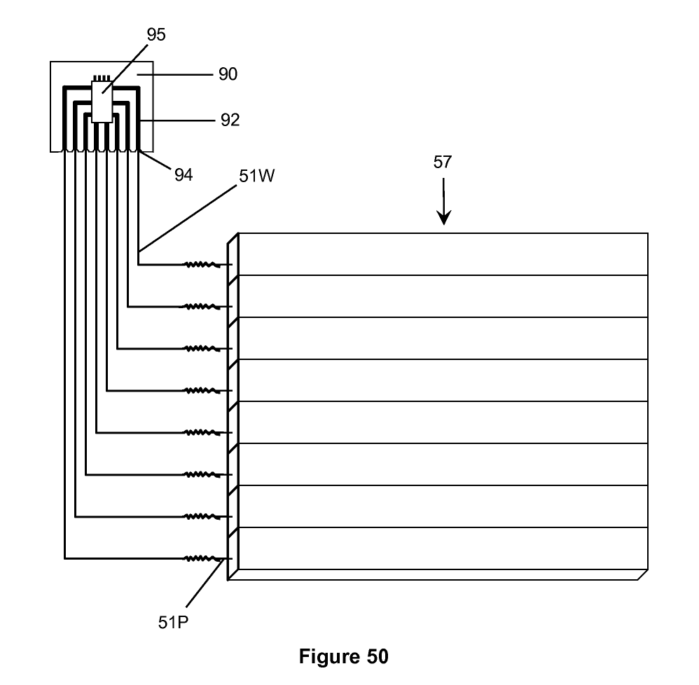

FIG. 50 shows the method of connecting the wire electrodes 51 from the plasma tubes 57 to the circuit board 90 such that the tube array 57 may be rolled. The wire electrodes 51 extend out of the plasma tubes 57 and are bent to a 90 degree angle. The wire electrodes 51 extend up past the top edge of the first plasma tube and are electrically connected to the drive electronics. To keep the wire electrodes 51 separated they may be embedded or sandwiched in a polymer or silicone film. The wire electrodes 51 may also be embedded or attached to the side(s) of the electroded sheet that attaches to the surface of the tube array (not shown). The gas processed plasma tubes 57 may have short wires 51P extending out of the ends of the tube 57 and additional wires 51W may be attached to the wire electrodes 51P to cover the long distances from the ends of the plasma tubes 57 to the circuit board 90. This additional wire 51W may be wire wrapped, crimped, welded or soldered to the wire electrodes 51P in the plasma tubes. The additional wire 51W may have a larger diameter and be of a different material than the wire electrode 51P in the tube array. Therefore, a higher temperature material, such as tungsten, may be used as the wire electrode 51P in the plasma tube 57 and a larger more highly conductive copper wire 51W may be wire wrapped onto the tungsten wire 51P and easily soldered into the printed circuit board 94. The wire electrodes 51 may be alternatively taken out of both sides of the plasma tube array 57 and may also be attached to circuit boards 90 at the top or bottom of the tube array 57. The electroded sheet, which completes the tubular plasma display, is attached to the plasma tube array 57 with the electrodes arrayed orthogonal to the plasma tubes 57. Therefore, the printed circuit board attaching to the wire electrodes in the electroded sheet is at the top or bottom of the tube array 57, allowing for all the electronics to be on one edge, hence creating a rollable panel.

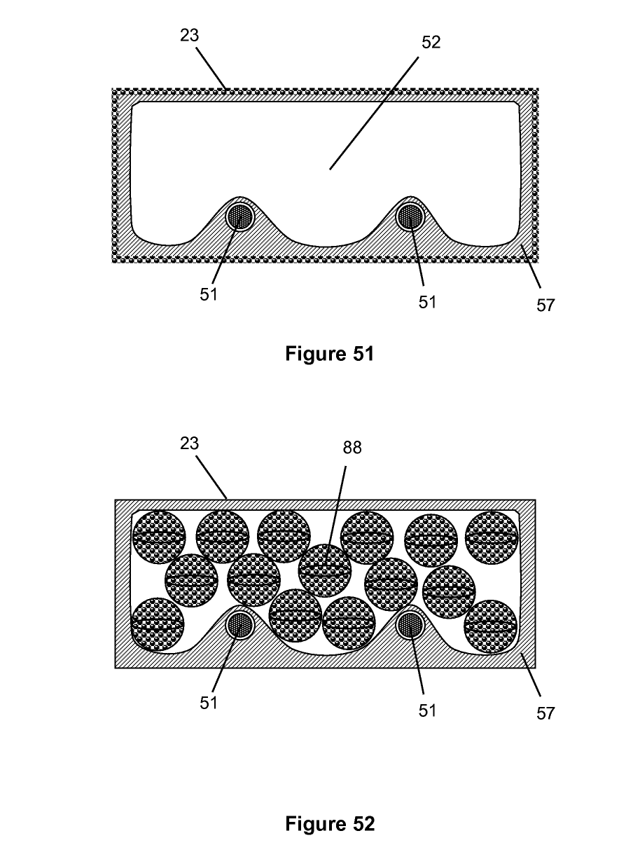

FIG. 51 shows a plasma tube 57 with the phosphor coating 23 on the outside of the plasma tube 57. The inside of the plasma tube 52 still houses the plasma gas and the ultraviolet light generated by the plasma has to transmit through the walls of the plasma tube to the phosphor coating. The advantage of this method is that is much easier to phosphor coat the outside of the tube than the inside. However, the walls of the plasma tube will have to be capable of transmitting the UV light. If xenon based gas is used for the UV generation, then the plasma tube has to be capable of transmitting 147 nm or 183 nm photons. Most low cost, low forming temperature glass compositions are not very transmissive at these high energies.

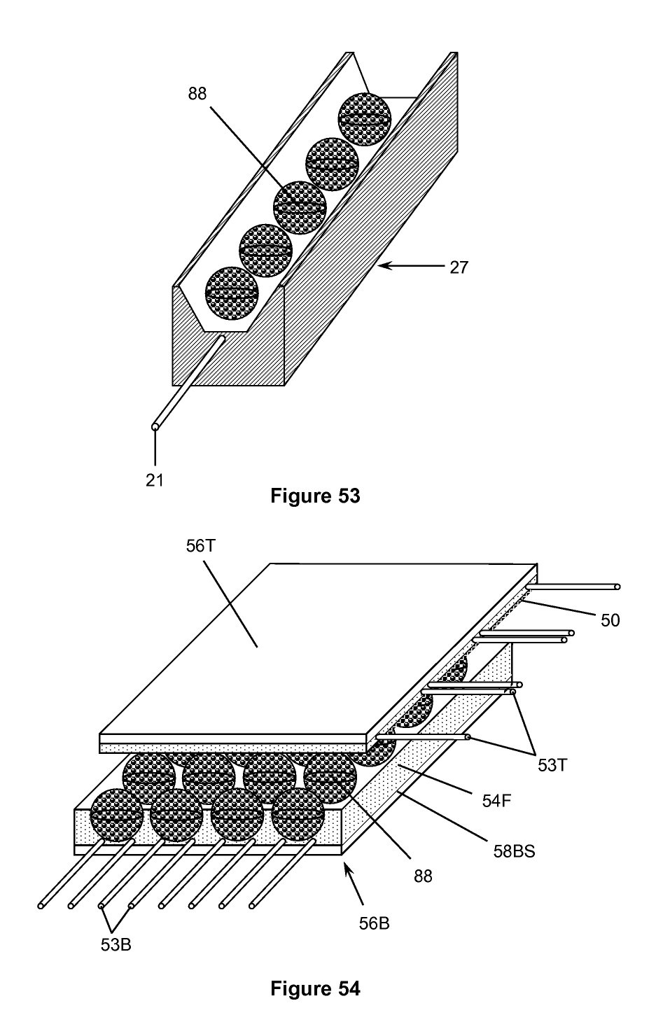

FIG. 52 shows a tube 57 filled with plasma spheres 88. The plasma spheres 88 are coated with a phosphor layer and filled with a plasma gas. The plasma spheres 88 may be filled with a very pure plasma gas and then coated with a phosphor coating. The plasma spheres 88 may then be placed into the plasma tubes 57. Since the plasma spheres 88 are composed of glass, they are capable of containing their own plasma gas, therefore the plasma tubes 57 do not have to be sealed and they may even be composed of a polymer material. However, in order to get a high transmission of the UV through the walls of the plasma spheres 88 in some embodiments, they need to be composed of a high temperature glass, which traditionally has a high diffusion coefficient. Therefore, to increase the operating lifetime of the spheres 88, it is advantageous to fill the plasma tubes 57 with a similar plasma gas. In one embodiment, plasma tubes 57 with red, green and blue phosphor coated plasma spheres 88 are arrayed and connected to an electroded sheet to form a plasma display.

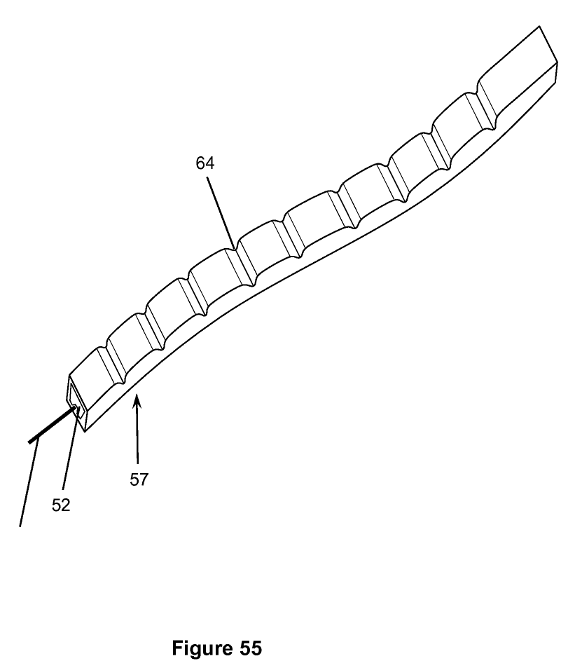

FIG. 53 shows the phosphor coated plasma spheres 88 placed in the channel of a fiber 27. More than one layer of plasma spheres 88 may be placed in the fiber 27 channel if the plasma spheres 88 are much smaller than the fiber 27 channel depth. The fiber 27 containing a wire electrode 21 may be composed of a polymer material and may be sealed to an electroded sheet. The fibers 27 are preferably composed of a colored polymer or glass or have a color coating on the surface matching the color of the phosphor coating on the plasma spheres 88. Therefore, if the viewer is on the fiber 27 side of the panel, the color purity of the light generated from the phosphor coated plasma spheres 88 is enhanced and the bright room contrast is dramatically improved.

FIG. 54 shows the phosphor coated plasma spheres 88 sandwiched between two orthogonal electroded sheets 56. The top electroded sheet 56T contains wire electrodes 53T connected to a transparent conductive coating 50 to form electrode lines. The bottom electroded sheet 56B is composed of a substrate 54S containing wire electrodes 53B embedded in a thick polymer film 54F. Plasma spheres 88 are also embedded in the thick polymer film 54F. If the plasma spheres 88 have colored phosphor coatings, then they will be aligned to at least one set of wire electrodes 53 in the electroded sheets 56. The plasma spheres 88 may alternatively be mixed in a polymeric binder and placed between two orthogonal electroded sheets 56.

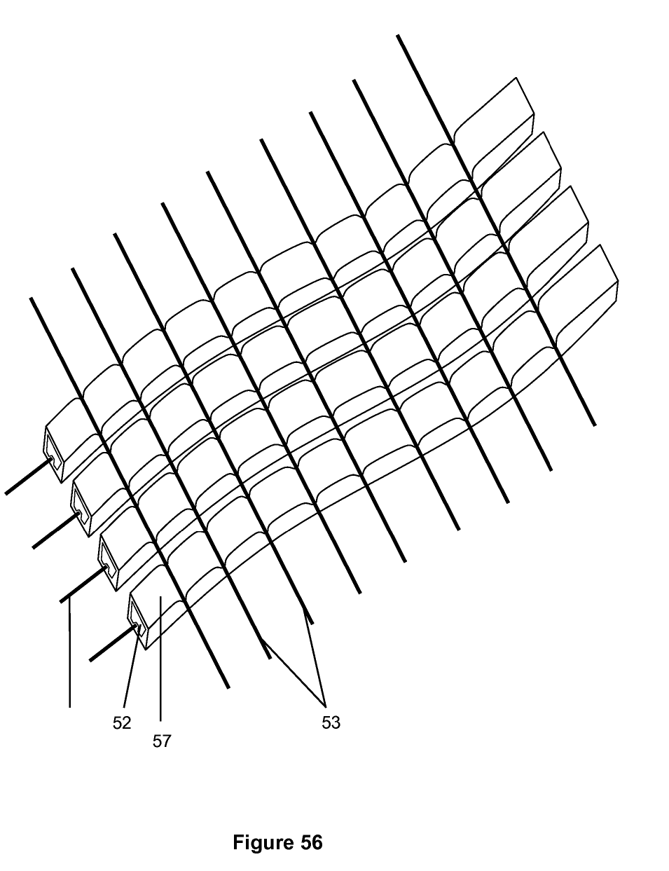

FIG. 55 shows a plasma tube 57 with grooves 64 embossed into the surface of the tube 57. These grooves 64 can support wire electrodes 53 to form a tubular plasma display, as shown in FIG. 56. Attaching the wire electrodes 53 to the tubes 57 removes the substrate requirement and allows for the fabrication of extremely large plasma displays. The wire electrodes 53 may be coated with a silicone film to enhance there long-term adhesion to the tube surface. Carbon nanotubes may be added to the silicone to reduce the voltage drop between the wires 53 and the tube surface and to spread out the effect of the electric field. Applying a sustaining voltage between adjacent wires 53 in the wire array will create a plasma inside 52 the plasma tubes 57. The electric field generated by applying the voltage on these adjacent wire electrodes 53 will be predominately dropped across the gas, since the wires 53 are located in the grooves 64 below the surface of the tube 57. Dropping the majority of the voltage across the gas will create the lowest firing voltage for a surface discharge configuration. Pin-pointing the firing to a line or wire 53 across the tubes 57 will concentrate the damage to that location, thus limiting the amount of phosphor damage inside the tube. The protrusions inside the tube, as a result of the grooves 64 in the surface, will create barriers to flow and help collect or concentrate a hard emissive coating has it is flushed through the tube. This concentration of the hard emissive coating at the wire electrode 53 locations will help reduce the plasma damage and increase the secondary electron emission in turn lowering the firing and sustaining voltages of the plasma display.

The grooves 64 can be formed in the tube 57 surface using a standard embossing tool. However, the tube 57 will get flattened during this process step. The tubes 57 could reside in small channels to prevent the tube 57 from being flattened when the grooves 64 are embossed. Grooves 64 could also be formed in the tube 57 surface by blow molding. In this pressurized molding process the tubes 57 are placed in a mold with the opposite structure of the desired grooved 64 tube surface. The tubes 57 and the mold are then brought up above the softening point of the glass (preferably to the working point) and pressurized. The pressure will force the surface of the tube out into the mold and form the grooved surface 64.

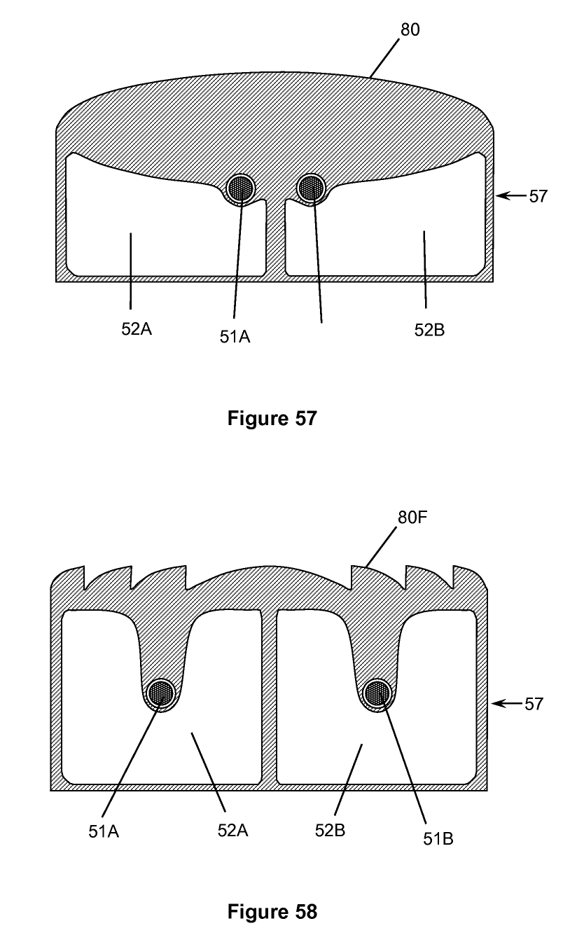

FIG. 57 shows a plasma tube 57 with two plasma chambers 52 and a curved surface to act as a lens 80. The two plasma chambers 52A and 52B are preferably individually addressed using the two wire address electrodes 51A and 51B, respectively. Light coming from the two plasma chambers 52 through the lens 80 creates two separate views. Addressing a suitable image in the left (A) and right (B) plasma cells 52A and 52B creates a three-dimensional image when the viewer is positioned in the center of the display. Note that the viewer has to be positioned on the lens 80 side of the plasma tubes 57. Since the plasma generated light is transmitted out of the tube array 57 on the opposite side of the tube 57 from where the electroded sheet is attached, the electroded sheet does not have to be transparent. In fact, if the electroded sheet is reflective it reflects the plasma generated light escaping out of the back side of the display. Color filters may also be added to the plasma tubes 57 to enhance the color purity and bright room contrast of the display.

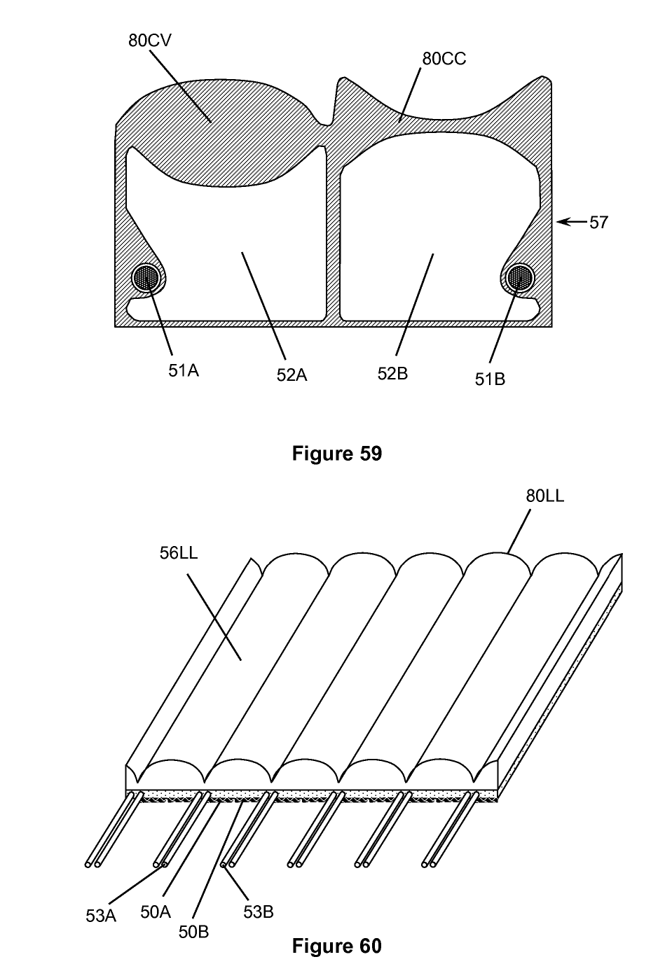

FIG. 58 shows the lens 80 on the tube as a Fresnel-based lens 80F, where the lenticular lens 80 in FIG. 57 is collapsed down onto a plane to form a lens 80F that produces the same lens function. The wire electrodes 51A and 51B are preferably moved to the center of the plasma cells 52 to enhance the addressability of the plasma in each cell 52. The wire electrodes 51 may also be placed in the walls of the plasma tubes 57 to bring them closer to the addressing surface, as shown in FIG. 59. Bringing the wire address electrodes 51 closer to the addressing surface lowers the addressing voltage, increases the addressing speed, and enhances the addressability of the plasma cell 52. Placing the wire electrodes 51 in the walls of the plasma tubes 57 also has two major optical advantages. First, the wire electrodes 51 are not located in the main light transmission region of the plasma tube 57, therefore the wire electrodes block minimal light. Second, the wire electrodes 51 are not located in the lens 80 formed regions, thus the wire electrodes do not affect the lens function of the panel. FIG. 59 also shows that the lens may be any shape from concave 80CC to convex 80CV. Using two different lens curvatures creates a 3-D image, where the two images get focused at different depths in the panel. More than two plasma cells with corresponding lens may be formed in each plasma tube yielding more than two possible images. Single plasma tubes with a lens function, light blocking layers, different index of reflection glasses and a multitude of lens configurations may be used in a tubular plasma display similar to that disclosed in U.S. Pat. No. 7,082,236, incorporated herein by reference.

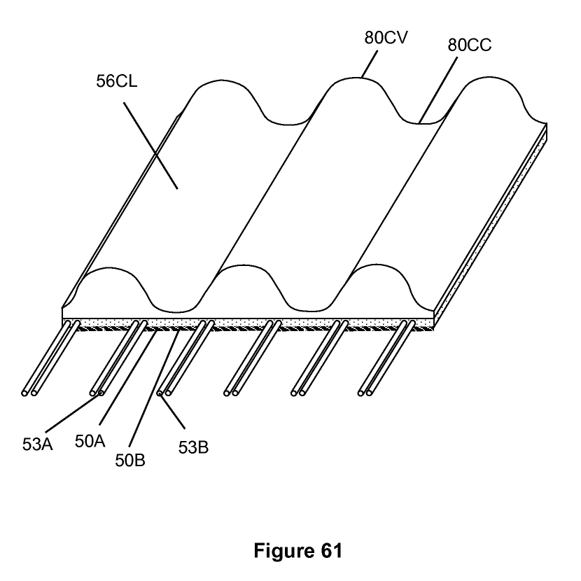

FIG. 60 shows the lens function to create multiple images or a 3-D image included in the electroded sheet 56. In this example, a lenticular lens 80LL is embossed into the electroded sheet 56LL. The lenses 80LL are aligned to the electrodes 53/50 in the electroded sheet 56LL. The lenses 80LL may be embossed into the surface of the electroded sheet 56LL or they 80LL may be formed in a separate polymer sheet and bonded to an electroded sheet. Several different lens functions including concave 80CC and convex 80CV may be formed in the surface of an electroded sheet 56CL, as shown in FIG. 61. Fresnel-based lenses both in lenticular and circular form may be formed in the electroded sheets, however if a circular or rectangular Fresnel-based lens is used it also has to be aligned to the plasma tube array.

All of the patents, patent publications, and nonpatent references discussed herein are hereby incorporated by reference in their entireties.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tubular plasma display comprising:
a) at least one tube to form structure within the display; and
b) an electroded sheet comprising a polymer substrate that comprises at least one wire electrode.

2. The tubular plasma display of claim 1, wherein the plasma tube is mechanically connected to the electroded sheet.

3. The tubular plasma display of claim 2, further comprising a pressure sensitive contact adhesive that attaches the plasma tube to the electroded sheet.

4. The tubular plasma display of claim 1, wherein the tube comprises at least one wire electrode.

5. The tubular plasma display of claim 4, further comprising a conductive filler added to the wire electrode in the tube, wherein the conductive filler removes a capacitive gap between wire and glass tunnel walls.

6. The tubular plasma display of claim 1, wherein the tube comprises a phosphor coating.

7. The tubular plasma display of claim 1, wherein the tube comprises a hard emissive coating.

8. The tubular plasma display of claim 7, wherein the hard emissive coating comprises nanoparticles, nanotubes, or nanorods.

9. The tubular plasma display of claim 1, wherein the tube comprises at least one color filter coating.

10. The tubular plasma display of claim 9, wherein a top of the tube includes a first color filter coating and a bottom of the tube includes a second color filter coating different from the first color filter coating.

11. The tubular plasma display of claim 1, wherein the tube comprises a colored glass to add a color filter the plasma display.

12. The tubular plasma display of claim 1, wherein at least part of at least one side of the tube comprises a black section selected from the group consisting of a black coating; a black glass; and a black absorbing material, wherein the black section serves a black matrix function in the plasma display or as a visor to block sunlight from entering the tube.

13. The tubular plasma display of claim 1, wherein the tube comprises texture or structure on the inside or outside tube surface, wherein the texture or structure performs a function selected from the group consisting of:
a) assists in firing a plasma inside the tube;
b) redirects light escaping out of the tube; and
b) reflects light out of the display.

14. The tubular plasma display of claim 1, wherein the tube includes curved edges that increase a mechanical strength of the tube.

15. The tubular plasma display of claim 1, wherein the tube has a bottom that is thicker than a top.

16. The tubular plasma display of claim 1, wherein the tube includes a surface coating that strengthens a surface of the glass tube and resists scratches.

17. The tubular plasma display of claim 1, wherein the at least one tube comprises at least three different phosphor colored tubes, where at least one of the three phosphor colored tubes has a different width than at least one of the other three phosphor colored tubes to change a relative luminous form of that colored phosphor tube.

18. The tubular plasma display of claim 1, wherein the at least one wire electrode in the electroded sheet is connected directly to drive electronics.

19. The tubular plasma display of claim 1, wherein the wire electrode in the electroded sheet comprises a plurality of wire electrodes.

20. The tubular plasma display of claim 1, further comprising a conductive layer electrically connected to the wire electrode in the electroded sheet, wherein the conductive layer spreads an extent of a voltage or electric field from the wire electrode across a surface of the electroded sheet.

21. The tubular plasma display of claim 20, wherein the conductive layer forms a web between two wire electrodes.

22. The tubular plasma display of claim 20, wherein the conductive layer comprises a material selected from the group consisting of:
a) a metal coating;
b) a conductive polymer;
c) a hard transparent conductive coating;
d) a nanotube coating;
e) a nanorod coating;
f) a Baytron conductive polymer;
g) an indium tin oxide film;
h) a plurality of carbon nanotubes;
i) a plurality of silicon nanorods; and
j) any combination of a) through i).

23. The tubular plasma display of claim 1, wherein the tube comprises a phosphor coated fiber inside the tube.

24. The tubular plasma display of claim 23, further comprising a wire electrode in the fiber.

25. The tubular plasma display of claim 24, further comprising a conductive filler added to the wire electrode, wherein the conductive filler removes a capacitive gap between the wire and glass tunnel walls.

26. The tubular plasma display of claim 23, further comprising a conductive coating on a surface of the fiber.

27. The tubular plasma display of claim 23, further comprising a wire electrode inside the tube.

28. The tubular plasma display of claim 23, further comprising a getter material between the tube and the fiber.

29. The tubular plasma display of claim 1, further comprising a getter material inside the tube.

30. The tubular plasma display of claim 1, further comprising a hard emissive coated fiber inside the tube.

31. The tubular plasma display of claim 30, further comprising a plurality of nanotubes added to the hard emissive coated fiber.

32. The tubular plasma display of claim 1, wherein the tube comprises a glass that reflects ultraviolet radiation.

33. The tubular plasma display of claim 1, further comprising a phosphor coated fiber and a hard emissive coated fiber inside the tube between a plurality of tube seals.

34. The tubular plasma display of claim 1, further comprising a phosphor coating applied to an inside surface of the tube.

35. The tubular plasma display of claim 1, further comprising a polymeric or silicone material that fills the ends of the tubes and strengthens the tube ends.

36. The tubular plasma display of claim 1, further comprising a second sheet added to a back side of the at least one tube, wherein the second sheet protects the tube from particulates.

37. The tubular plasma display of claim 36, further comprising a liquid added around the at least one tube, between the second sheet and electroded sheet, wherein the liquid performs a function selected from the group consisting of:
a) removing heat from the tubes;
b) removing at least one reflection;
c) reducing a frictional force between tubes; and
d) any combination of a) through c).

38. The tubular plasma display of claim 1, wherein the tube is sealed closed at each end and an angle that the tube ends make with a tube body is less than 5 degrees, such that the tubular plasma display may be rolled around a tube seal or along a length of the electroded sheet without breaking the tube around a seal area.

39. The tubular plasma display of claim 1, further comprising at least one first wire electrode added to the at least one tube, such that the first wire electrode extends away from an end of the tube, is bent, and is connected to electronics on an edge normal to the tube end.

40. The tubular plasma display of claim 39, further comprising a second wire electrically connected to the wire electrode in the tube, wherein the second wire covers a distance between the tube and electronics.

41. The tubular plasma display of claim 1, further comprising electronics, wherein all electronics are located on one side of the display.

42. The tubular plasma display of claim 41, wherein the display is rollable.

43. The tubular plasma display of claim 1, further comprising electronics, wherein all electronics are located on opposing sides of the display.

44. The tubular plasma display of claim 43, wherein the display is rollable.

45. The tubular plasma display of claim 1, wherein the tube comprises a plurality of plasma channels across a width of the tube.

46. The tubular plasma display of claim 1, further comprising a lens added to at least one surface of the tube.

47. The tubular plasma display of claim 46, wherein the lens is a lens selected from the group consisting of: a concave lens; a convex lens; a lenticular lens; and a Fresnel lens.

48. The tubular plasma display of claim 46, wherein the display shows multiple images at the same time.

49. The tubular plasma display of claim 46, wherein the display shows a three-dimensional image.

50. The tubular plasma display of claim 1, further comprising at least one lens added to a surface of the electroded sheet.

51. The tubular plasma display of claim 50, wherein the lens is embossed in the electroded sheet.

52. The tubular plasma display of claim 50, wherein the lens is formed in a separate lens sheet and attached to the electroded sheet.

53. The tubular plasma display of claim 50, wherein the display shows multiple images at the same time.

54. The tubular plasma display of claim 50, wherein the display shows a three-dimensional image.

55. The tubular plasma display of claim 1, wherein the tube comprises glass and a phosphor coating added to an outside surface of the tube, wherein the glass transmits ultraviolet radiation.

56. The tubular plasma display of claim 1, wherein the wire electrode in the electroded sheet protrudes less than 25 μm out of the electroded sheet and the wire electrode in the electroded sheet is less than 75 μm deep into the polymer substrate.

57. The tubular plasma display of claim 1, wherein the electroded sheet is flat.

58. The tubular plasma display of claim 1, further comprising at least three different color phosphor filled tubes, wherein at least one of the phosphor filled tubes is filled with a different gas composition or a different gas pressure than the other phosphor filled tubes.

59. The tubular plasma display of claim 1, further comprising a drive control system operating in an erase address mode, comprising electronics attached to a panel, wherein the electronics provide:
means for storing a charge on each pixel to turn each pixel ON; and
means for selectively removing said charge from at least one pixel by applying an erase pulse to its corresponding electroded sheet wire electrode and an electrode in the tube, thereby turning said at least one pixel OFF.

60. The tubular plasma display of claim 1, further comprising a drive control system operating in a write address mode, comprising electronics attached to a panel, wherein the electronics provide:
means for removing a charge from each pixel, thereby turning each pixel OFF; and
means for adding charge to at least one pixel by applying a voltage to its corresponding electrode sheet wire electrode and an electrode in the tube, thereby turning said at least one pixel ON.

61. The tubular plasma display of claim 1, further comprising a drive control system that uses a ramped voltage to set an initial charge inside the tube.

62. The tubular plasma display of claim 1, wherein the display is addressed in a progressive mode of operation, wherein every line in the display is operated per video frame.

63. The tubular plasma display of claim 1, wherein the display is addressed in an interlaced mode of operation, wherein every other line in the display is operated per video frame.

64. The tubular plasma display of claim 1, further comprising at least one plasma sphere inside the tube.

65. The tubular plasma display of claim 1, further comprising a surface modification film added to at least part of the plasma tube surface.

66. A plasma tube for an electronic display comprising a top, a bottom and sides, wherein the sides have a larger volume of glass than the top or bottom surfaces to pull the top or bottom surface flat during a tube draw process.

67. A plasma tube for an electronic display comprising a top, a bottom and sides, wherein the glass in the sides has a lower viscosity at a forming temperature than the top or bottom surfaces to pull the top or bottom surface flat during a tube draw process.

68. A double-sided tubular plasma display comprising an array of plasma tubes comprising a plurality of plasma tubes with phosphor coated channels on both sides of the plasma tubes, and two sustainer plates located on both sides of the plasma tube array.

69. The double-sided tubular plasma display of claim 68, wherein the sustainer plates comprise electroded sheets composed of a polymer substrate that comprise at least one wire electrode.

70. The double-sided tubular plasma display of claim 68, further comprising a fiber comprising a plurality of phosphor coated channels inside the plasma tubes.

71. A plasma display comprising at least one tube, wherein the tube comprises a wire electrode and at least one plasma sphere.

72. A plasma display comprising at least one fiber, wherein the fiber comprises a wire electrode and at least one plasma sphere.

73. A plasma display comprising at least one electroded sheet and at least one plasma sphere, wherein the electroded sheet comprises a polymer substrate and at least one wire electrode.

74. The plasma display of claim 73, wherein the at least one electroded sheet comprises two electroded sheets sandwiched around the at least one plasma sphere.

75. The tubular plasma display of claim 1, wherein the polymer substrate is a silicone substrate.

76. The tubular plasma display of claim 1, wherein the tube comprises an array of plasma tubes comprising at least one wire electrode per plasma tube; and the at least one wire electrode comprises an array of wire electrodes, wherein the array of plasma tubes is attached to the electroded sheet.

77. The tubular plasma display of claim 76, wherein each of the plasma tubes in the array of plasma tubes further comprises at least one phosphor coating, and at least one hard emissive coating.

78. The tubular plasma display of claim 77, wherein the array of wire electrodes is contained in the polymer substrate, and the electroded sheet further comprises a plurality of transparent conductive electrode stripes connected to the wire electrodes.

79. A method of fabricating a tubular plasma display comprising at least one tube to form structure within the display; and an electroded sheet comprising a polymer substrate that comprises at least one wire electrode, comprising the step of placing the wire electrode into the electroded sheet and at least one substep selected from the group consisting of:
a) forcing the wire into a surface of the electroded sheet through a die;
b) pressing the wire into the surface using a plate;
c) pressing the wire into the surface using a roller;
d) pulling the wire into the surface when wrapped on a drum;
e) pulling the wire into the surface when on an arced plate;
f) drawing the wire directly into the polymer substrate;
g) placing the wire on a substrate and overcoating with a second polymer film;
h) laminating the wire between polymer films; and
i) any combination of a) through h).

80. A method of fabricating a tubular plasma display comprising at least one tube to form structure within the display; and an electroded sheet comprising a polymer substrate that comprises at least one wire electrode, comprising the step of adding a phosphor coating to the display and at least one substep selected from the group consisting of:
a) flushing a phosphor solution through the tube;
b) pulling a phosphor solution through the tube;
c) blowing a phosphor through the tube;
d) using electrostatic attraction when delivering the phosphor through the tube;
e) coating a surface of the electroded sheet with an adhesive coating, then delivering the phosphor through the tube and having the phosphor bond to the adhesive coating;
f) coating the phosphor during a tube draw process; and
g) any combination of a) through f).

81. A method of fabricating a tubular plasma display comprising at least one tube to form structure within the display; and an electroded sheet comprising a polymer substrate that comprises at least one wire electrode, comprising the step of applying a coating to an inner tube surface during a tube draw process, wherein the coating is selected from the group consisting of:
a) a hard emissive coating;
b) a phosphor coating; and
c) both a hard emissive coating and a phosphor coating.

82. The method of claim 81, wherein the coating is fed down small delivery tubes and deposited onto the tube walls in a root of the draw.

83. A method of fabricating a tubular plasma display comprising an array of plasma tubes comprising at least one color filter coating, comprising the step of applying the color filter coating to the plasma tubes after the plasma tubes are gas processed.

84. The method of claim 83, wherein the color filter coating is applied using a substep selected from the group consisting of:
a) pulling the tube across a coating head;
b) dipping the tube in a colored solution;
c) spraying the tube with a color coating; and
d) any combination of a) through c).

85. An emissive tubular plasma display comprising:
a) an array of tubes with electrodes to form structure within the display;
b) an array of wire electrodes positioned nominally orthogonal to the tube array; and
c) a photoluminescent material dispersed within the tubes such that said photoluminescent material emits light in the visible spectrum when a plasma is ignited inside the tubes by applying voltages to the electrodes.
